(19) United States
(12) Patent Application Publication
(10) Pub. No.: US 2013/0298209 A1
(43) Pub. Date: Nov. 7, 2013

(54) ONE ROUND TRIP AUTHENTICATION USING SNGLE SIGN-ON SYSTEMS

(71) Applicant: INTERDIGITAL PATENT HOLDINGS, INC., (US)

(72) Inventors: Yousif Targali, Cliffwood, NJ (US); Vinod K. Choyi, Norristown, PA (US); Yogendra C. Shah, Exton, PA (US); Aamer Sattar Chaudry, Karben (DE); Andreas Schmidt, Frankfurt am Main (DE); Andreas Leicher, Frankfurt (DE)

(21) Appl. No.: 13/834,643

(22) Filed: Mar. 15, 2013

Related U.S. Application Data
(60) Provisional application No. 61/641,622, filed on May 2, 2012.

(51) Int. Cl. H04L 29/06

(52) U.S. Cl. CPC H04L 63/0815
USPC 726/6

(57) ABSTRACT

Systems, methods, and apparatus embodiments are described herein for enabling one-round trip (ORT) seamless user/device authentication for secure network access. For example, pre-established security associations and/or credentials may be leveraged between a user/device and a network entity (e.g., application server) on a network to perform an optimized fast authentication and/or to complete security layer authentication and secure tunnel setup in an on-demand and seamless fashion on the same or another network.

### CROSS-REFERENCE TO RELATED APPLICATIONS

This Application claims the benefit of U.S. Provisional Application Ser. No. 61/641,622, filed May 2, 2012, the contents of which are hereby incorporated by reference in their entirety.

### BACKGROUND

Typically a network access entity or service, such as a hotspot network access point for example, requires a user to obtain and enter credentials to access the network. Further, the user's credentials (e.g., username, password, keys) are typically provisioned on the network in which the user seeks access. For example, a hotspot network may require a user to provide sensitive data, such as a credit card number, to access the network. Such user input introduces security risks and imposes authentication burdens on the user. Additionally, a connection to a hotspot access point is often insecure, and existing approaches to provisioning a device with an identity and credentials for authentication often add latency to authentication protocols which may degrade a user's experience. Further, existing approaches can be inefficient, for example, by generating and maintaining un-used keys.

For example, an extensible authentication protocol (EAP) framework specifies an authentication framework at the link layer. A device may use full EAP authentication to gain network access via an access point (AP). A fast EAP method can be used to authenticate a device more quickly than a full EAP when the device arrives at a previously visited AP, if the device has a valid keying material that was derived from a previous full EAP authentication at that AP. But fast EAP authentication may include several EAP exchanges and round trips, resulting in latencies. Some extensions to EAP, such as EAP-reauthentication protocol (EAP-RP) for example, present their own inefficiencies.

### SUMMARY

Systems, methods, and apparatus embodiments are described herein for enabling one-round trip (ORT) seamless user/device authentication for secure network access. For example, pre-established security associations and/or credentials may be leveraged between a user/device and a network entity (e.g., application server) on a network to perform an optimized fast authentication and to complete security layer authentication and secure tunnel setup in an on-demand and seamless fashion on the same or another network.

In one example embodiment, a user equipment (UE) establishes a security association with a single sign-on (SSO) server on a first network. For example, the first network may be a cellular network. Via the first network, the UE discovers a network identity of an access point that resides on a second network. For example, the second network may be a WLAN network, such as a hotspot network. Further, the UE may wish to access the second network at a future time. The UE derives, with the SSO server, dynamically generated credentials, such as a master session key (MSK) for example. The dynamically generated credentials may be used to authenticate to an access point on the second network. In the example embodiment, the UE performs an optimized authentication using the dynamically generated credentials to gain secure access to the access point via the second network. Thus, the UE leverages credentials that are derived over the first network to gain a secure access to a different network. The optimized authentication may be in accordance with the extensible authentication protocol (EAP) framework, for example.

### BRIEF DESCRIPTION OF THE DRAWINGS

A more detailed understanding may be had from the following description, given by way of example in conjunction with the accompanying drawings wherein:

FIG. 1A is a flow diagram illustrating an example embodiment for performing single sign-on (SSO) based one round trip authentication (ORTA) access;

FIG. 1B is a flow diagram illustrating another example embodiment for performing SSO based ORTA access, wherein the ORTA is implemented in accordance with extensible authentication protocol (EAP);

FIG. 2 is a flow diagram illustrating an example embodiment of ORTA using an SSO system that is implemented in accordance with extensible authentication protocol (EAP) reauthentication protocol (EAP-RP);

FIG. 3 is a flow diagram illustrating application layer based authentication with a single service set identifier (SSID) according to an example embodiment;

FIG. 4 is a flow diagram that uses an SSO system for establishing a secure network connection using two SSIDs and a generic bootstrapping architecture (GBA) framework in accordance with an example embodiment;

FIG. 5 is a flow diagram that uses an SSO system for establishing a secure network connection using two SSIDs and an OpenID Connect framework in accordance with an example embodiment;

FIG. 6A illustrates an example embodiment of ORTA using an SSO system that is implemented in accordance with EAP-AKA and is triggered using an EAP-Response message;

FIG. 6B illustrates an example embodiment of ORTA using an SSO system that is implemented in accordance with EAP-AKA and is triggered using an EAPoL-Start message;

FIG. 6C illustrates another example embodiment of ORTA using an SSO system that is implemented in accordance with EAP-AKA and is triggered using an EAP-Response message;

FIG. 6D illustrates another example embodiment of ORTA using an SSO system that is implemented in accordance with EAP-AKA and is triggered using another example EAPoL-Start message;

FIG. 7 is a call flow illustrating an example embodiment of encapsulating OpenID messages inside EAP;

FIG. 8 is a call flow illustrating an example embodiment of leveraging a pre-existing security association (SA) to generate a key;

FIG. 9 is a flow diagram that uses an SSO system for establishing a secure network connection using one SSID and an OpenID Connect framework in accordance with an example embodiment in which OpenID functionality is performed locally;

FIG. 10 is a flow diagram illustrating an example of EAP-AKA full authentication;

FIG. 11 is a flow diagram illustrating an example of EAP-AKA fast re-authentication.

FIG. 12 is flow diagram illustrating an example of EAP-RP authentication;

FIG. 13 illustrates an example derivation of a re-authentication root key (rRK);

FIG. 14A is a system diagram of an example communications system in which one or more disclosed embodiments may be implemented;

FIG. 14B is a system diagram of an example wireless transmit/receive unit (WTRU) that may be used within the communications system illustrated in FIG. 14A; and

FIG. 14C is a system diagram of an example radio access network and an example core network that may be used within the communications system illustrated in FIG. 14A.

### DETAILED DESCRIPTION OF ILLUSTRATIVE EMBODIMENTS

The ensuing detailed description is provided to illustrate exemplary embodiments and is not intended to limit the scope, applicability, or configuration of the invention. Various changes may be made in the function and arrangement of elements and steps without departing from the spirit and scope of the invention.

Systems, methods, and apparatus embodiments are described herein for enabling one-round trip (ORT) seamless user/device authentication for secure network access. In an example embodiment, security associations and credentials may be established between a user/device and a network entity (e.g., application server) on a first network for use in a second network. In an example embodiment, the first network is a cellular network and the second network is a WLAN network such as a hotspot network. The security associations and credentials from the first network may be leveraged to perform an optimized fast authentication and to complete security layer authentication and secure tunnel setup in an on-demand and seamless fashion on the same or a different network. While the embodiments described herein are often described in the context of OpenID protocols, embodiments are not limited to implementing the OpenID protocols, and may implement other single sign-on (SSO) protocols and/or federated identity protocols for example. Similarly, while OpenID entities are often used as references herein, embodiments are not limited to OpenID entities, and the OpenID entities may be extendable to other entities that perform the same, or similar, functions as OpenID entities. For example, as used herein, the terms relying party (RP) and client may refer to a service provider (SP), such as a service website or a network access point. The terms OpenID identity provider (OP) and authorization server may refer to a network identity provider (IdP) or an authentication endpoint (AEP). The term user equipment (UE) may refer to any appropriate wireless transmit/receive unit (WTRU), as further described herein.

Embodiments described herein may use pre-established security associations and credentials between the user/user equipment (UE) and a first network entity to enable an optimized fast-extensible authentication protocol (EAP) access to a different network. In an example embodiment, an optimized EAP re-authentication protocol (EAP-RP) is used to access a network or service based on security associations that are pre-established and credentials that are dynamically generated. Security associations may be pre-established between a user/UE and a single sign-on (SSO) system such as OpenID, OpenID Connect, Generic Bootstrapping Architecture (GBA), or the like. The optimized fast-EAP and EAP-RP authentications may enable one-round trip (ORT) mutual authentication and generation of session keys.

In an example embodiment, a user/UE requests and obtains discovery information from a first network entity. Such information may include, for example, an access point (AP) identity (e.g., MAC address or SSID), security protocols that are supported (e.g., AP support of EAP-RP, EAP, or the like), and type of cryptosuites supported (e.g., HMAC-SHA-256, HMAC-SHA-512, or the like). The network entity receives discovery requests and sends network discovery information to the user/UE. For example, network discovery information may be sent to the UE via the access network discovery and selection function (ANDSF) over a cellular network (e.g., using Open Mobile Alliance (OMA) device management (DM) protocol or the like). Alternatively, network discovery information may be sent to the UE via Layer 2 protocols (e.g., 802.11u using Generic Advertisement Service (GAS) and access network query protocol (ANQP)).

In another example embodiment, a user/UE discovers a network (e.g., AP) to which it may wish to connect at a future time. The user/UE obtains the discovered network's identity, via a first network entity for example. The user/UE communicates the discovered identity to the first network entity which acts as a facilitator for authentication between the UE and the discovered network. For example, the user/UE may inform the discovered network to anticipate a connection request from the UE so that the discovered network can expect the connection request from the user/UE and can establish a security association with the user/UE. Such network discovery information may be sent over various layers of a communications stack such as, for example, the applications layer, the layer 3, and the layer 2 protocols. The UE may, for example concurrently with the Authentication and/or Association procedure, request and obtain internet protocol (IP) address configurations from the discovered network in an implicit or explicit manner. For example, a UE may request an IP address (e.g., implicitly or explicitly) during an EAP authentication. The first network entity may receive an address configuration request and may send IP address configurations to the UE. For example, the first network entity may request IP address configurations on behalf of a UE based on implicit or explicit requests from the UE. According to an example embodiment, IP address configurations are sent to the UE via the ANDSF over cellular networks. In another example embodiment, IP address configurations are sent to the UE via an authentication, authorization, accounting (AAA) server, for example, in EAP-Success or EAP-Finish messages. In yet another example embodiment, IP address configurations are sent to the UE via Layer 2 protocols (e.g., EAP notify messages).

In an example embodiment described herein, a temporary or permanent ORT authentication (ORTA) identity is created and sent to the user/UE, for example, during a security association establishment phase between the user/UE and a first network entity. The temporary or permanent identity may also be derived by the UE and/or the first network entity, for example, using shared cryptographic means. In another example embodiment, a network entity verifies a temporary or permanent ORTA identity that is received from the user/UE, and the network entity correlates the ORTA identity with an existing security association context between the user/UE and the network entity. The UE and the network entity may negotiate and select a protocol for EAP authentication. For example, the UE may concurrently request IP address configurations using the dynamic host configuration protocol (DHCP) that may be carried inside EAP messages as part of EAP negotiation. The UE and the network may negotiate and select a cipher suite, for example, for deriving keys and for securing communications between the UE and the network.

The Internet Engineering Task Force's (IETF's) Extensible Authentication Protocol (EAP) specifies an authentication framework at the link layer using entities such as a supplicant (e.g., client), an authenticator (e.g., an access point), and an authentication server (e.g., AAA server). The authenticator transfers EAP message between the supplicant and the server. For example, messages are EAPOL-encapsulated on the wireless side and RADIUS encapsulated on the wired side. As a result of successful full EAP authentication, the client is allowed network access and the traffic that is sent over the radio link is encrypted. EAP authentication enhances WLAN security by providing mutual authentication between the client and the network, secure transfer of authentication credentials, and generation of keying material for session encryption keys.

For example, when a device arrives at a new authenticator, it may perform full EAP authentication. The device may perform fast EAP authentication, for example, if the device comprises fresh keying material that was derived from a previous full EAP authentication. Performing conventional fast EAP authentication involves multiple EAP exchanges and round trips to complete the EAP authentication, potentially resulting in a poor end user experience. As described herein, SSO systems may be used and pre-established user/UE and network security associations and credentials may be used to optimize fast EAP and EAP-RP authentication protocols.

In various embodiments described herein, authentication is implemented in accordance with the Extensible Authentication Protocol (EAP). Various EAP implementations provide full authentication or fast EAP authentication, and generate session keys to secure communications between the user equipment (UE) and the network. Although ORT authentication may be described herein with reference to the EAP UMTS Authentication and Key Agreement (EAP-AKA) protocol, the same or similar concepts may be applied to other authentication protocols such as, for example, EAP Transport Layer Security (EAP-TLS), EAP Tunneled Transport Layer Security (EAP-TTLS), EAP Subscriber Identity Module (EAP-SIM), EAP-AKA Prime (EAP-AKA′), and the like.

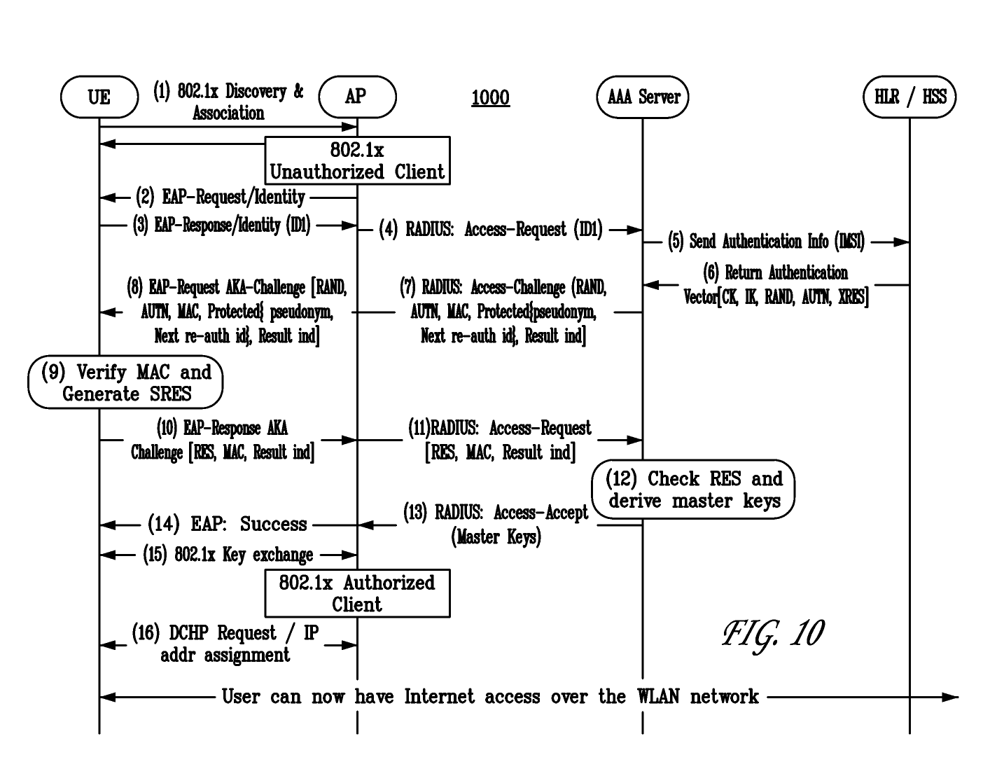

FIG. 10 illustrates an example full EAP-AKA call flow 1000. With reference to FIG. 10, The EAP-AKA protocol is one of several EAP variants that provide mutual authentication and generate session keys. The EAP-AKA authentication protocol uses the UMTS Authentication and Key Agreement (AKA) mechanism. EAP-AKA allows a mobile operator to use a common authentication infrastructure for both UMTS and WLAN access.

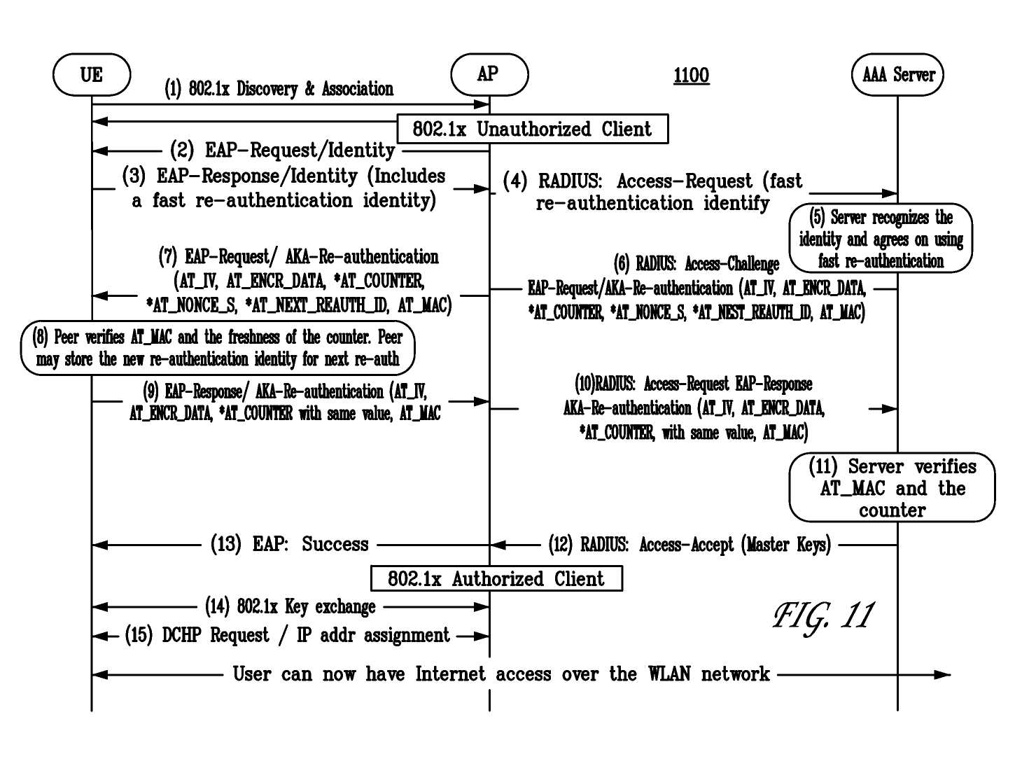

FIG. 11 illustrates an example fast EAP-AKA call flow 1100. With reference to FIG. 11, conventional EAP-AKA full authentication requires fresh authentication vectors from an operator's authentication center and involves multiple operations and round trips to complete the authentication. The EAP-AKA protocol includes the option for a fast re-authentication that does not use the AKA algorithms and does not need new vectors from the operator's authentication center. Conventional EAP-AKA fast re-authentication is based on keys derived during a preceding full EAP-AKA authentication. For example, the authentication keys (K_aut) and encryption keys (K_encr) that are used in full authentication may be used to protect fast EAP-AKA messages and attributes, and the original master key from full authentication may be used to generate a fresh master session key.

The fast re-authentication exchange may make use of an unsigned 16-bit counter, which may be included in an “AT_COUNTER” attribute. For example, the counter may be used to limit the number of successive re-authentication exchanges without full-authentication. The counter may contribute to the keying material, and the counter may protect the peer and the server from replays. The counter attribute may be encrypted. In an example implementation of EAP-AKA fast re-authentication, the server includes an encrypted server random nonce in the fast re-authentication request. The AT_MAC attribute in the peer's response is calculated over NONCE_S to provide a challenge/response authentication scheme. The NONCE S also contributes to the new master session key. Thus, conventional EAP-AKA fast re-authentication involves multiple EAP exchanges and round trips to complete the EAP authentication. Multiple exchanges and round trips may add latencies that affect the user experience.

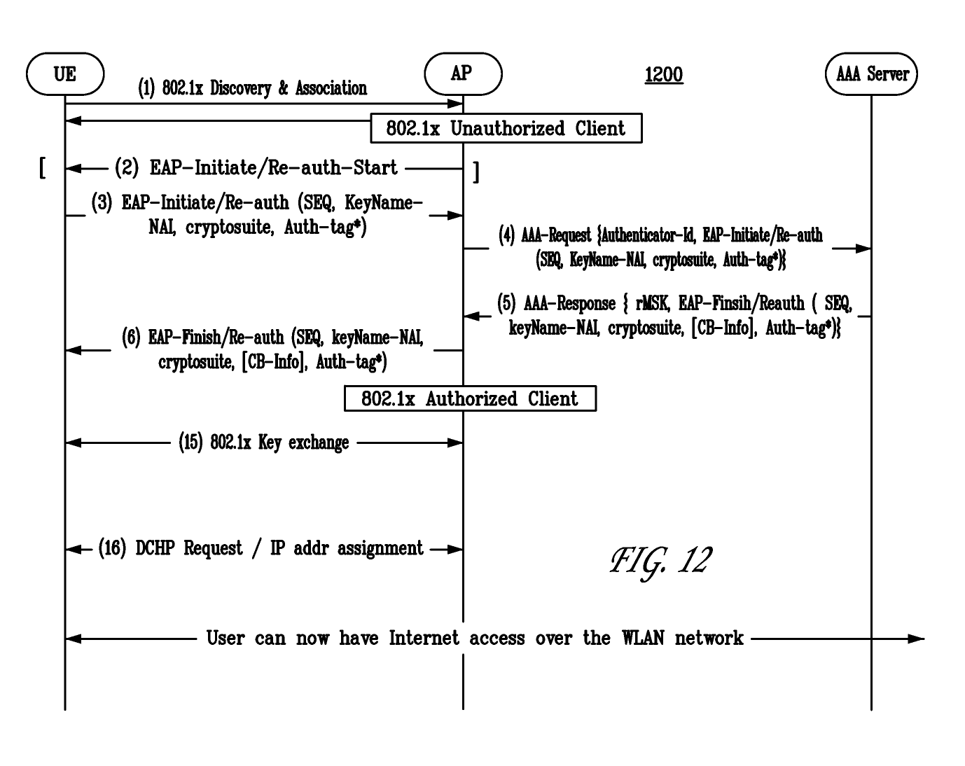

FIG. 12 illustrates an example EAP-RP call flow 1200. With reference to FIG. 12, conventional EAP-RP extends the base EAP to improve the EAP authentication. The EAP-RP describes a set of extensions to EAP to enable re-authentication of a peer that has already establish at least a portion of EAP key material with the EAP server in a previous full authentication phase. The conventional extensions include EAP codes referred to as EAP-Initiate and EAP-Finish.

With continuing reference to FIG. 12, the typical EAP-RP call flow 1000 includes the peer, the authenticator, and the EAP-RP server (e.g., AAA server). The EAP-RP assumes that the peer performs a full EAP authentication with the AAA server and that both entities share an EMSK. From the EMSK, the peer and the AAA server derive a key named rRK. From the rRK, a new key named Re-authentication Integrity Key (rIK) is derived to provide proof of possession and authentication during the re-authentication.

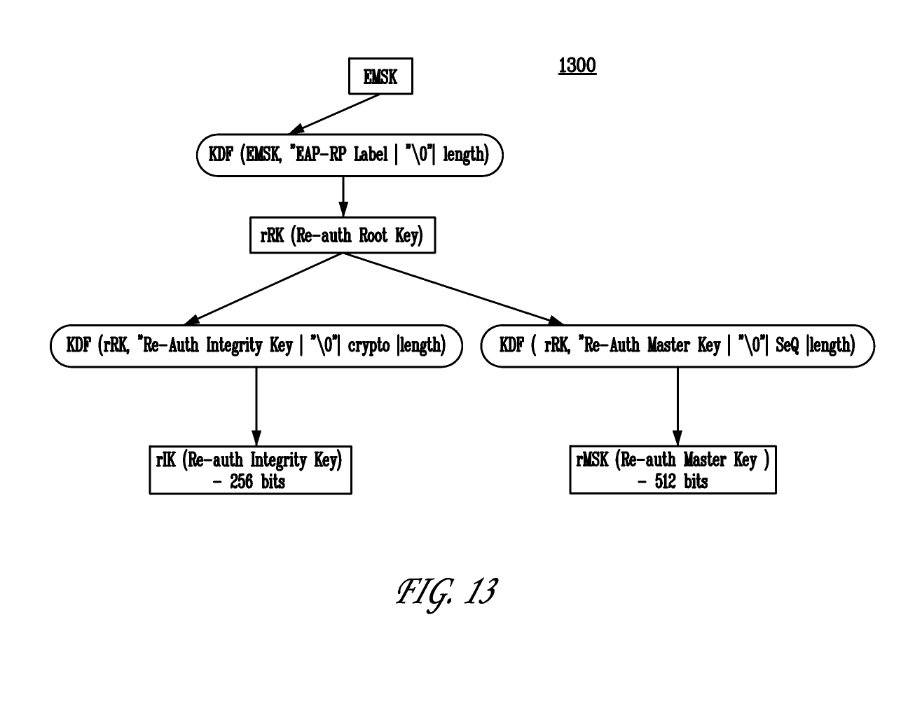

FIG. 13 illustrates an example derivation 1100 of a re-authentication root key (rRK). With reference to FIG. 13, conventional EAP-RP defines the derivation of a re-authentication root key (rRK) which is to be used as the root key for the EAP-RP authentication. The rRK is derived from the EMSK that is generated as part of the full EAP. A re-authentication integrity key (rIK) that is derived using the rRK is used for proof-of-possession , and thus authentication of the peer. EAP-RP messages generated by the UE and AAA server are integrity protected using the rIK. In a conventional EAP-RP implementation, a re-authentication master session key (rMSK) is derived for use in the derivation of session keys that are derived as part of a 4-way handshake protocol. A generic KDF is used, for example, to support various EAP protocols, but the key algorithm is often based on HMAC-SHA. Because different EAP implementations employ different key lengths, the key algorithm can be used to generate 64, 128, and/or 256 bit keys.

Implementing conventional EAP-RP may require modifying existing EAP implementations to support the EAP-RP extensions. For example, the EAP-RP extensions may require updating or replacing the UE, AP, and/or the AAA entities. A conventional EAP-RP implementation is triggered by the AP sending an EAP-Initiate/Re-auth-Start message. In such an implementation, the AP may not know whether the UE supports EAP-RP or whether the UE recently performed a full EAP authentication through another AP. Further, there may be conflict between EAP-RP and other EAP protocols if multiple protocols are running between the UE and the AP at the same time.

Conventional EAP-RP assumes that the base key (e.g., EMSK 512 bits) used for re-authentication key generation is derived out of a full EAP authentication that includes at least two round-trips, adding latency. The key (e.g., EMSK) that is generated as part of the full EAP, for example, may not be used unless there is a re-authentication in a conventional EAP-RP implementation. Thus, there is an overhead cost associated with generating and maintaining/securing unused keys.

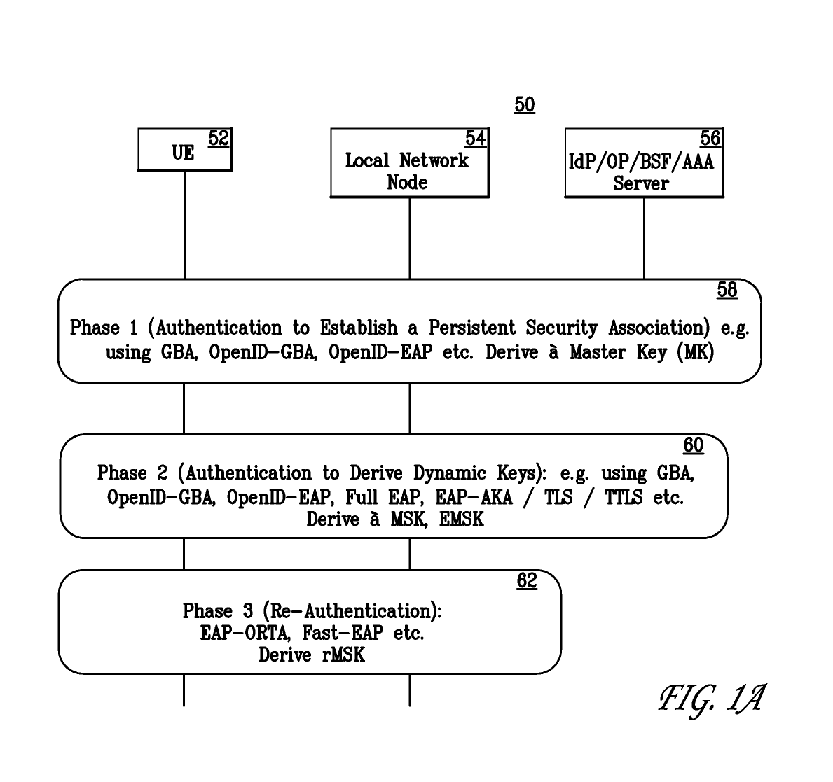

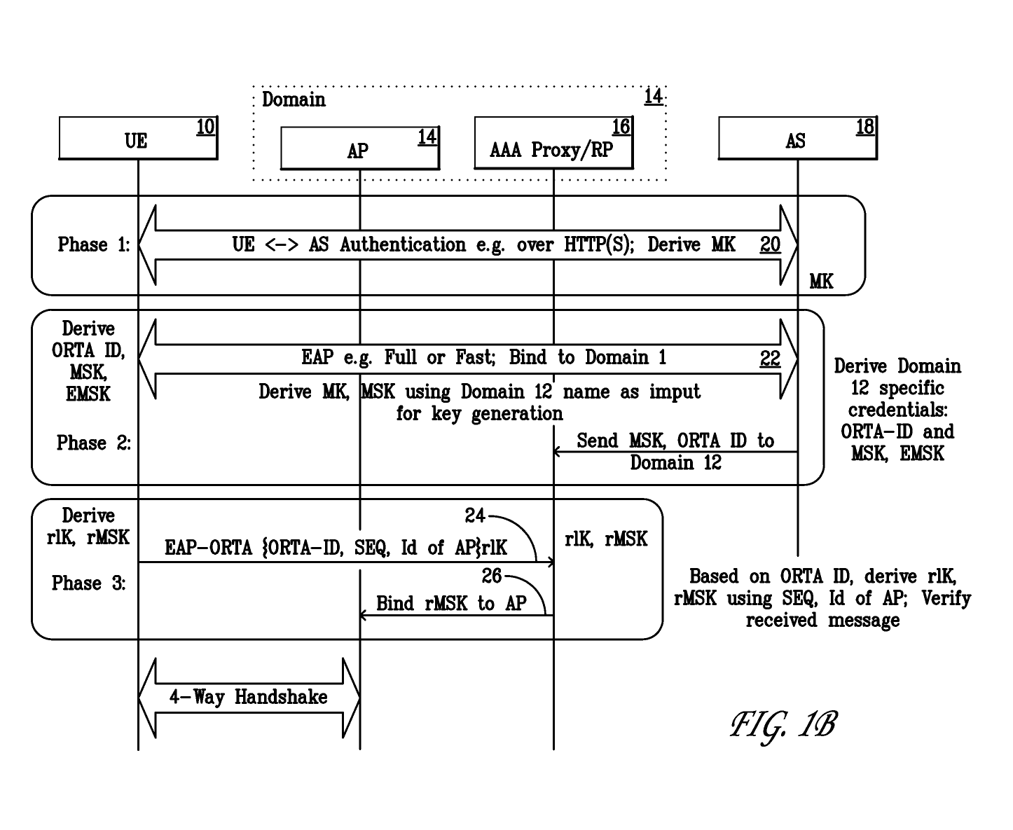

FIG. 1A illustrates a general flow 50 for performing single sign-on (SSO) based one round trip authentication (ORTA) access according to an example embodiment. The general flow 50 is divided into 3 phases: phase 1, phase 2, and phase 3. In accordance with the illustrated embodiment, a UE 52, a local network node 54, and an identity provider (IdP) 56 are connected such that they are discoverable amongst each other and able to communicate with each other. For example, the local network node 54 may discover the IdP 56 based on an identity of the UE 52. The identity of the UE 52 may provide sufficient information to enable discovery of the IdP 56 and may be communicated to the local network node 54 by the UE 52. Alternatively, the IdP 56 may discover the local network node 54 based on information provided to it by the UE 52. The UE 52 may obtain information about the local network node 54 based on broadcast information, which may provide sufficient information to enable discovery of the local network node 54 by the IdP 56. In accordance with the example embodiment, the UE 52 may communicate with the IdP 56 to enable the UE 52 to discover and communicate with the local network node 54. The local network node 54 may implement functions of an access point (AP), an AAA proxy, and/or a relying party (RP), thus the local network node 54 may also be referred to as an AP 54, an AAA proxy 54, or an RP 54, without limitation. The IdP 56 may implement functions of an identity provider such as an OpenID identity provider (OP), a Bootstrapping Server Function (BSF) as specified by 3GPP, or an AAA server, and thus the IdP 56 may also be referred to as an OP 56, a BSF 56, or an AAA server 56, without limitation.

Referring to FIG. 1A, at 58 (phase 1), a persistent security association between the UE 52 and the IdP 56 is created at any layer of a communications stack. In an a preferred embodiment, the security association is created at the application layer. In accordance with the illustrated embodiment, phase 1 is implemented over a first network, such as a cellular network or a WLAN for example. For example, phase 1 implements application layer authentication between the UE 52 and the IdP 56. The application layer authentication may result in the derivation of one or more keys, such as a ciphering key and/or an integrity key, which may be used to create a Master Key (MK). The application layer authentication may be implemented in accordance with various protocols such as GBA, OpendID, OpenID Connect, or the like, or in accordance with a network layer authentication such as EAP. At 60 (phase 2), authentication occurs between the UE 52 and the IdP 56. Such authentication may be at the access, network, or application layer. An identity of a second network that is different than the first network is discovered during phase 2. For example, the second network may be a WLAN network or a hotspot network. Such an identity may comprise the identity of local network node 54. Thus, the local network node 54 may be part of a WLAN or a hotspot network. Keys are generated at phase 2, such as a master session key (MSK) or an EMSK for example, which are specific to the authentication mechanisms used by the second network. The keys may be bound to the UE 52 and the second network. Phase 2 may be implemented using various messaging protocols, such as HTTP messages at the application layer or EAP messages at the network layer for example. The access layer authentication in phase 2 may be implemented in accordance with EAP, EAP-AKA/TLS, or the like. In accordance with the illustrated embodiment, phase 2 may implemented over the first network which may be a cellular network or a WLAN or phase 2 may be implemented via the second network. The keys may be used during phase 3 in accordance with the illustrated embodiment.

Still referring to the illustrated embodiment shown in FIG. 1A, at 62 (phase 3), the UE 52 is authenticated with the second network at the local network node 54. Thus, the UE 52 establishes secure access to the internet via the local network node 54. Further, the illustrated UE 52 has leveraged credentials derived between the UE 52 and the IdP 56, which may have been carried out over the first network (e.g., a cellular network), to gain a secure access to the second network (e.g., a WLAN). As described in detail below, phase 3 may be implemented in accordance with various protocols such as EAP, Fast-EAP, EAP-RP, or EAP-ORTA, for example, which are compatible with the second network.

FIG. 1B illustrates a flow diagram for performing SSO based one round trip authentication (ORTA) access according to an example embodiment in which EAP is implemented. For explanatory purposes, FIG. 1B is divided into three phases: phase 1, phase 2, and phase 3, which are consistent with the three phases in FIG. 1A. In the illustrated embodiment, a UE 10 may also be referred to as a peer 10, and a domain 12 includes an access point 14 and an AAA proxy 16. The AAA proxy 16 may implement an application layer functionality, and thus may be referred to as, a service provider (SP) 16 or a relying party (RP) 16. Similarly, the illustrated embodiment includes an authentication server (AS) 18 which may be implemented by, and thus referred to as, an identity provider (IdP) 18 such as an OpenID identity provider (OP) 18. The AS 18 may also be referred to as an AAA server 18, without limitation.

In accordance with the illustrated embodiment, during phase 1 at 20, the UE 10 uses its identity to mutually authenticate with the AS 18. For example, the UE 10 may use its operator provided identity (e.g., ue_id@att.com) or an identity provided by an identity provider (e.g., ue_name@gmail.com) to mutually authenticate with the AS 18. The AS 18 may be controlled by a mobile network operator (MNO). Such authentication may be implemented over HTTP with, for example, a Generic Bootstrapping Architecture (GBA) protocol, an OpenID/EAP protocol, an OpenID Connect/EAP protocol, or the like. Or the authentication may be carried out with, for example, an access layer protocol such as EAP. Keys are derived from the mutual authentication at 20. For example, a Master Key (MK) may be derived from a ciphering key (CK) and/or an integrity key (IK) when GBA is implemented at 20. In accordance with the illustrated embodiment, the mutual authentication at 20 is completed before access to a service or network access at domain 12. For example, the mutual authentication at 20 may be completed in anticipation of access to a service, such as in anticipation of access to a hotspot network at domain 12 for example. The lifetime of the keys that are generated at 20 may vary (e.g., key lifetimes of days, hours, etc.). Such keys may be bound to the AS 18 and the identity of the UE 10. In an example embodiment, phase 1 is skipped if there is a valid security association between the UE 10 and the AS 18.

Still referring to FIG. 1B, during phase 2 at 22, the UE 10 initiates an optimized EAP or an OpenID authentication based on network indications or other means. Such network indications may depend on geolocation, time of day, or the like. In accordance with the illustrated embodiment, at 22, the UE 10 requests access to a network resource that is controlled by a domain, such as the domain 12. For example, the request may include a request to access a network such as a hotspot network, or the request may include a request to access various other network resources such as websites and applications. Such network resources may be controlled by a single domain (e.g., boingo.com, microsoft.com, verizon.com). In accordance with the illustrated embodiment, the UE 10 initiates phase 2 by discovering the identity of the domain 12 to enable communications to the domain 12 by, for example, the AS 18. The identity may be sensed by the UE 10. The identity may be a network identity that is discovered using indications through an ANDSF protocol and/or 802.11u (e.g., GAS/ANQP) protocols. In accordance with another embodiment, the network identity may be discovered (e.g., sensed) by the UE 10 via advertisements from WLAN beacons such as the SSID and BSSID of the AP 14 (which enable the domain 12 to be uniquely and globally discoverable), and the UE 10 may then be referred to an Address Resolution Server to identify the IP Address of the AAA Proxy/RP 16 of domain 12. Alternatively, the UE 10 may communicate its identity to the AP 14 and/or the AAA Proxy/RP 16 of domain 12 from which the AS 18 may be discovered. For example, the AS 18 may have assigned the identity “ue_name@google.com” to the UE 10 which may be resolved, by domain 12, to discover the AS 18 by way of the unique address resolution of “google.com”. The “ue_name” may subsequently enable the AS 18 to uniquely identify the UE 10.

In accordance with the illustrated embodiment, at 22, the AS 18 and the UE 10 may compute the MSK and optionally an EMSK, and may bind the MSK to the domain 12. Thus, in accordance with the illustrated embodiment, the MSK becomes the domain root key for keys subsequently generated for access to resources within the domain 12, and a temporary identity (ORTA ID) is also derived. As described herein, the derived identity may be referred to as an one round trip authentication (ORTA) identity (ID). The ORTA ID may be used for identification purposes within the domain 12. For example, the temporary identity (OTRA ID) may have the same “realm” as that of the domain 12 such that the ORTA ID of the UE 10 is ue@domain12.com (e.g., ue@yahoo.com, ue@verizon.com, etc.). In accordance with the illustrated embodiment, phase 2 is repeated for access to a new domain with which the UE 10 does not have an association or bound secret MSK with a valid lifetime. In an example embodiment, phase 2 is skipped if there is a valid MSK associated with the domain even, for example, when a resource belongs to a different network (e.g., physically and/or logically). A valid MSK may refer to an MSK with a lifetime that has not expired, and thus is valid.

Still referring to the example embodiment shown in FIG. 1, during phase 3 at 24, the UE 10 generates an EAP message that comprises the ORTA ID of the UE 10. The EAP message is generated after the UE 10 identifies the resource that is required within the domain 12 (e.g., access to the hotspot AP 14). The EAP message may be protected by the rIK that was generated using the MSK as the root key. For example, the AAA proxy 16 may use the ORTA ID to verify that there is a corresponding MSK is stored locally. Thus, the AAA proxy 16 uses the MSK the domain root key to derive the re-authenticate integrity key (rIK). The AAA proxy 16 verifies the message, for example, based on the message authentication code derived using the rIK. At 26, the AAA proxy 16 derives a re-authentication master session key (rMSK) which is sent to the AP 14 and is bound to the UE 10 and AP 14. In accordance with the illustrated embodiment, the message is in accordance with EAP and is protected by the rIK. As described above, phase 3 is completed in one round trip and is based on a security association and/or keys derived during phase 1 and/or phase 2. In an example embodiment, phase 3 is repeated with any AP in the same domain that has an associated valid MSK and does not have valid rMSK associated with the AP. In such an embodiment, if the UE visits the same AP and has a valid rMSK, then phase 3 may be avoided and the rMSK may be used for a 4-way handshake. A valid MSK may refer to an MSK that has a lifetime that has not expired. Similarly, a valid rMSK may refer to a rMSK that has a lifetime that has not expired.

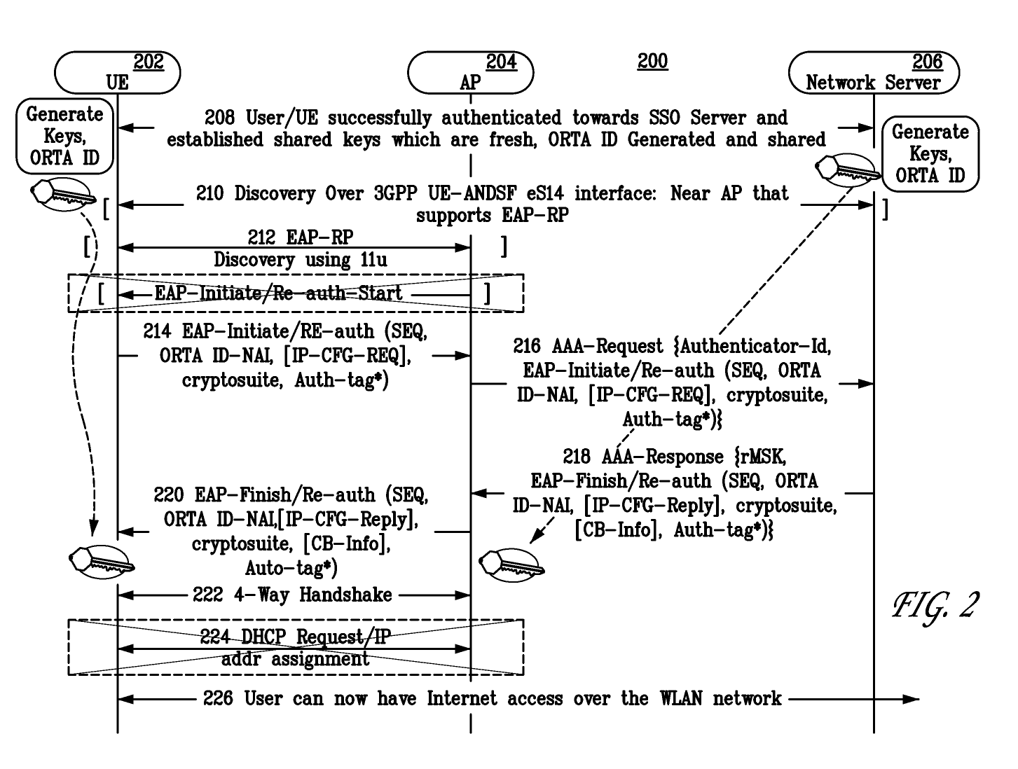

FIG. 2 illustrates an example embodiment of ORT EAP-RP authentication using an SSO system 200. The SSO system 200 includes a UE 202, an access point (AP) 204, and a network server 206. The network server 206 may implement an OpenID protocol, and thus may be referred to as an OpenID server 206. The network server 206 may also be referred to, without limitation, as an SSO server 206, a Federated Identity server 206, an access network discovery and selection function (ANDSF) server 206, or an AAA server 206. In accordance with the illustrated embodiment shown in FIG. 2, at 208, the UE 202 and the network server 206 have pre-established a security association and generated fresh master keys. In an example embodiment in which security association between the UE 202 and the network server 206 has not been established, an active connection, such as an active 3GPP connection for example, between the UE 202 and the network server 206 may be used to mutually authenticate and generate master keys on the UE 202 and the network server 206. At 208, an one round trip authentication (ORTA) ORTA identity (ID) is created and sent securely from the network server 206 to the UE 202. Such an ORTA ID may be used to trigger ORT EAP authentication and may be used by the network server 206 to find the existing security association context with the UE 202.

At 210, network discovery information may be exchanged between the UE 202 and the network. For example, the UE 202 may request wireless local area network (WLAN) information from the ANDSF server 206 (e.g., pull scenario) or the ANDSF server 206 may push WLAN information to the UE 202. The WLAN information may be pushed over a secure connection, such as a secure 3GPP connection for example. The network information that the UE 202 receives may comprise data such as available APs, SSIDs, authentication protocols which are supported (e.g., EAP or EAP-RP is supported), cryptosuites, IP address configurations, or other access network parameters that facilitate connection setup. In an alternative example embodiment, with reference to 212, network discovery information is obtained using lower layers such as by using 802.11u (e.g., using GAS and access network query protocol (ANQP)). In accordance with the illustrated embodiment, the network discovery information includes the AP 204 that supports the EAP-RP protocol , and thus the AP 204 does not need to send a EAP-Initiate/Re-auth-Start message to the UE 202.

At 214, in accordance with the illustrated embodiment, the UE 202, in response to the network discovery information informs the UE 202 that the AP 204 supports EAP-RP, sends an EAP-Initiate message to the AP 204. The initiate message includes the ORTA identity that may be securely stored in the UE. The initiate message may further include a sequence number (SEQ) for replay protection and a crypto suite that may be used. The initiate message may be protected using the integrity key. In an example embodiment, the UE 202 requests the IP address configuration by including a request (e.g., IP_CFG_REQ) in the EAP message at 214. In another example embodiment, the UE 202 may request IP address configurations by encapsulating DHCP requests inside EAP messages. In yet another example embodiment, the UE 202 may request and may obtain IP address configurations using EAP-Notify messages. At 216, the AP 204 forwards the EAP message (e.g., using AAA Request) to the network server 206. At 218, the network server 206 uses the ORTA identity to look up the pre-established security context with the UE 202. The network server 206 may verify the sequence number and may verify that the crypto suite used by the UE 202 is acceptable. The network server 206 may verify the integrity of the message using the rIK. For example, such a verification provides proof of the key possession by the peer 202. If the verifications are successful, the network server 206 generates and sends a session key to the AP 204. The session key may be sent with an EAP-Finish message.

Still referring to FIG. 2, in an example embodiment in which the UE 202 sends an IP configuration request (e.g., IP_CFG_FEQ) in the EAP-Response message, the network server 206 may send the IP configurations to the UE 202. For example, required IP configurations may be send in a IP CFG Reply field of the EAP-Finish message. The network server 206 may use various configuration protocols (e.g., DHCP, configured local address pool, or the like) to send address configuration information to the UE 202. The network server 206 may send channel binding information (CB-Info) in the EAP-Finish message, for example, for the UE 202 to verify that the EAP message was received via a valid AP. A valid AP may refer to an AP that has not been compromised. In accordance with the illustrated embodiment shown in FIG. 2, at 220, the AP 204 forwards the EAP-Finish message to the UE 202. At 222, a 4-Way Handshake protocol is performed between the UE 202 and the AP 204. IP address configuration may be performed at 224. In an example embodiment, IP address configuration is skipped at 224 because various IP concurrency options may be used. At 226, the UE 202, and thus a user of the UE 202, has access to the internet via the AP 204 and the WLAN network.

The EAR-RP ORTA identity may be associated with the network of the MNO. In an example embodiment, the EAP-RP ORTA identity may not be tied to the MNO's network. For example, the EAP-RP ORTA identity may be a temporary identity that is derived/issued and belongs to the hotspot network. Derived identities that belong to a hotspot network and may be comprised of various forms such as, for example, Base64(Rand x' or PrevAssociation#)@hotspot.com. In the example, PrevAssociation# represents a value from a previous association. Alternatively, derived identities may belong to an MNO network and may be comprised of various forms such as, for example, Base64(RAND x' or Seq#)@mno.com or Base64(KDF(RAND, “Temporary Identity|length”)@mno.com.

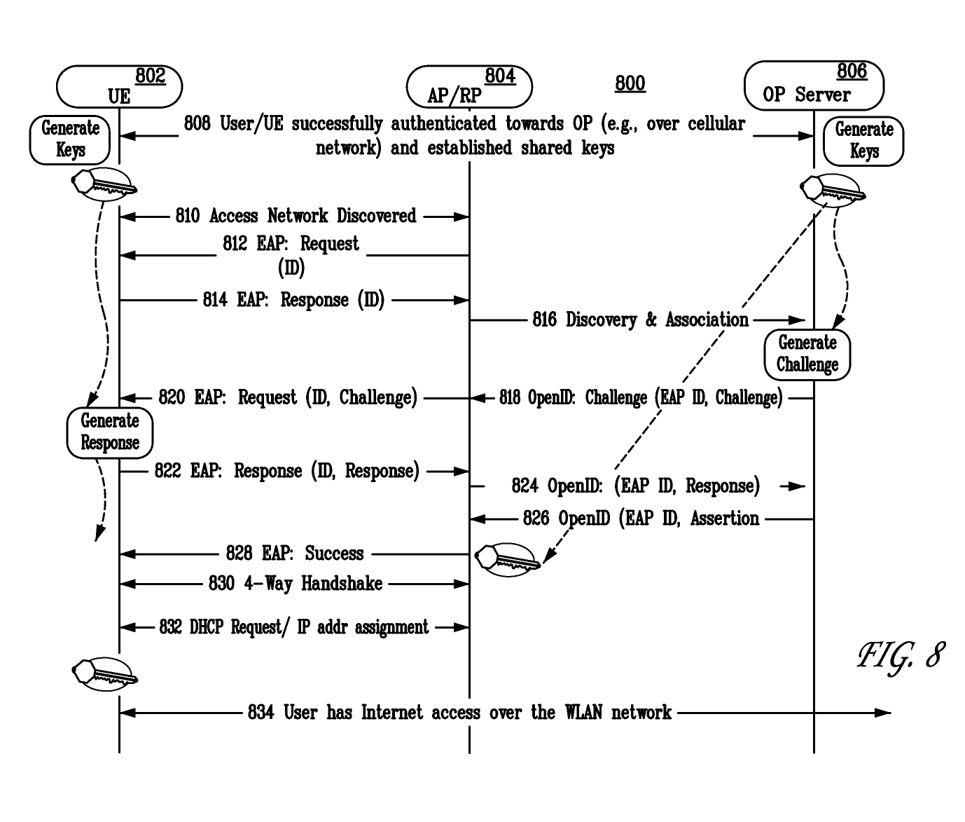

FIG. 8 illustrates an example embodiment of ORT EAP authentication using an SSO system 800 in which a security association is pre-established. Referring to FIG. 8, the SSO system 800 includes a UE 802, an AP 804, and an OpenID identity provider (OP) server 806. The AP 804 can be function as an OpenID relying party (RP) 804, and thus the AP 804 can be referred to as an RP 804, without limitation. In the SSO system 800, a security association between the UE 802 and the OP 806 is pre-established over a cellular network, at 808. Alternatively, the security association may be pre-established over another network. The security association results in master keys being generated on both the UE 802 and the OP 806. At some point after the security association has been established, the security association is leveraged to enable authentication and secure link setup on a WLAN network.

For example, in accordance with the illustrated embodiment, at 810, an access network, for instance the AP 804, is discovered by the UE 802. At 812, an EAP request message that requests an identity of the UE 802 is sent to the UE 802 from the AP 804. At 814, the UE 802 responds with its identity. At 816, the AP 804 performs discovery of the OP 806 based on the identity of the UE 802, and performs an association with the OP 806. The OP 806 generates a challenge, and sends the challenge to the AP 804, at 818. The challenge may be an OpenID challenge. At 820, the challenge is forwarded to the UE 802. The UE 802 generates a response to the challenge, and sends the response to the challenge to the AP 804, at 822. The response may be sent in accordance with EAP and the response may include the identity of the UE 802. At 824, the challenge response is forward to the OP 806. If the OP 806 verifies the identity of the UE 802 based on the challenge response, the OP 806 provides an assertion to the AP 804, at 826. At 828, the AP 804 forwards the EAP-Success message to the UE 802. At 830, a 4-Way Handshake protocol is performed. IP address configuration is performed at 832. At 834, the UE 802, and thus a user of the UE 802, has secure access to the internet via the AP 804 and the WLAN network.

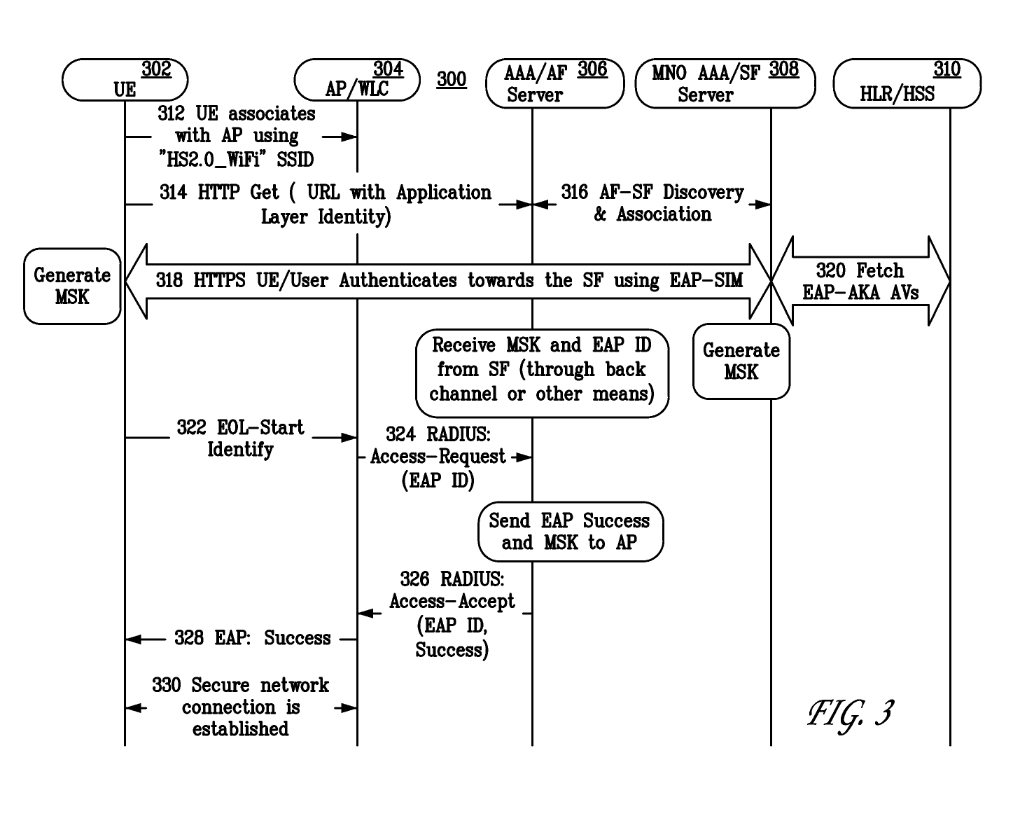

FIG. 3 illustrates an example SSO system 300 that implements a generic application layer based authentication with a single service set identifier (SSID) for establishing a secure network connection between a UE 302 and an AP 304. The application layer based authentication that is illustrated in FIG. 3 may be referred to as generic because FIG. 3 does not implement a specific protocol, but various embodiments of the illustrated application layer authentication may implement various protocols such as HTTP, OpenID, OpenID Connect, GBA, or the like. In an example embodiment, software of the AP 304 is modified such that it allows application layer authentication to be performed. The credentials generated via the application layer protocol may be used to provide optimized secure HotSpot 2.0 (HS 2.0) access. There is no need for the connection manager (CM) to disconnect and reconnect in the illustrated embodiment shown in FIG. 3. In accordance with the illustrated embodiment, the SSO system 300 includes the UE 302, the AP 304, a hotspot AAA server 306, an MNO AAA server 308, and a home location register (HLR)/home subscriber system (HSS) 310. The hotspot AAA server 306 includes an application function (AF) module. The AF module may be an RP in an example embodiment which implements OpenID/OpenID Connect, or the AF module may be a network application function (NAF) in an example embodiment that implements GBA. The MNO AAA server 308 includes a server function (SF) module. The SF module may be an OP in an example embodiment which implements an OpenID/OpenID Connect protocol, or the SF module may be a Bootstrapping Server Function (BSF) in an example embodiment which implements GBA. As described herein, EAP may be implemented over application layer authentication to generate session keys and credentials and an optimized EAP is implemented to gain HS 2.0 network access.

Still referring to the illustrated embodiment shown in FIG. 3, at 312, the UE 302 discovers the hotspot access point (AP) 304. The illustrated hotspot AP 304 may also be referred to as a wireless LAN controller (WLC) 304, without limitation. For example, a local component on the UE 302 (e.g., a CM) may discover the hotspot and its identification information such as an HS 2.0 SSID. The hotspot AP 304 allows application layer protocol exchanges to pass through to a walled garden before authentication, via access layer signaling such as a beacon channel or 802.11u GAS/ANQP protocol extension for example. In accordance with the illustrated embodiment, the CM decides that the UE 302 should connect to the hotspot network. At 314, the CM of the UE 302 sends an HTTP Get message with its application layer identity to the application function (AF) of the AAA server 306. At 316, from the application layer identity, the corresponding MNO server function (SF) of the AAA server 308 is discovered by the AF and association is done between the SF and the AF. At 318, the CM of the UE 302 authenticates with the MNO SF Server using EAP-SIM for example. The EAP-SIM exchanges between the UE and the MNO SF are carried out using HTTPS in accordance with the illustrated embodiment. At 320, the MNO SF obtains the authentication vectors (AVs) for EAP-SIM authentication from the HLR 310, via MAP or Diameter Gateway for example. At the end of successful EAP-SIM authentication, session keys (MSK) are created and stored on the UE and MNO AAA server 308.

In accordance with the illustrated embodiment, at 322, the UE 302 sends its EAP identity (EAP ID) to the AP/WLC 304 (e.g., using EOL-Start Identity). The realm of the EAP ID may include a hint to use an existing security context between the UE and the network (e.g., IM-SI@sso.MNO.org). At 324, the AP/WLC 304 sends a RADIUS Access-Request message (e.g., containing the EAP ID) toward the AAA Server/AF 306. At 326, the AAA Server/AF 306 sends EAP-Success along with the MSK that it received from the MNO SF 308 (at 318) to the AP/WLC 304 using a RADIUS Access-Accept message for example. At 328, the AP/WLC 304 forwards the EAP success message to the UE 302. Based on the MSK that is shared between the UE 302 and the AP/WLC 304, the 4-way handshake protocol is performed and pairwise transient keys (PTKs) and group transient keys (GTKs) are derived on both sides. The status of the UE 302 may become “authorized” on the AP 304 and the UE 302 may obtain IP address configurations using DHCP. In an alternative embodiment, the CM of the UE 302 has a private address at 312 that is used for OpenID authentication. In such an embodiment, the network changes the authorization for this address from “Walled Garden” to “Authorized access” and the UE 302 does not need to go through DHCP procedure. At 330, the UE 302, and thus the user of the UE 302, has established a secure network connection with the AP 304, and has secure HS 2.0 access to the internet according to the example embodiment of FIG. 3.

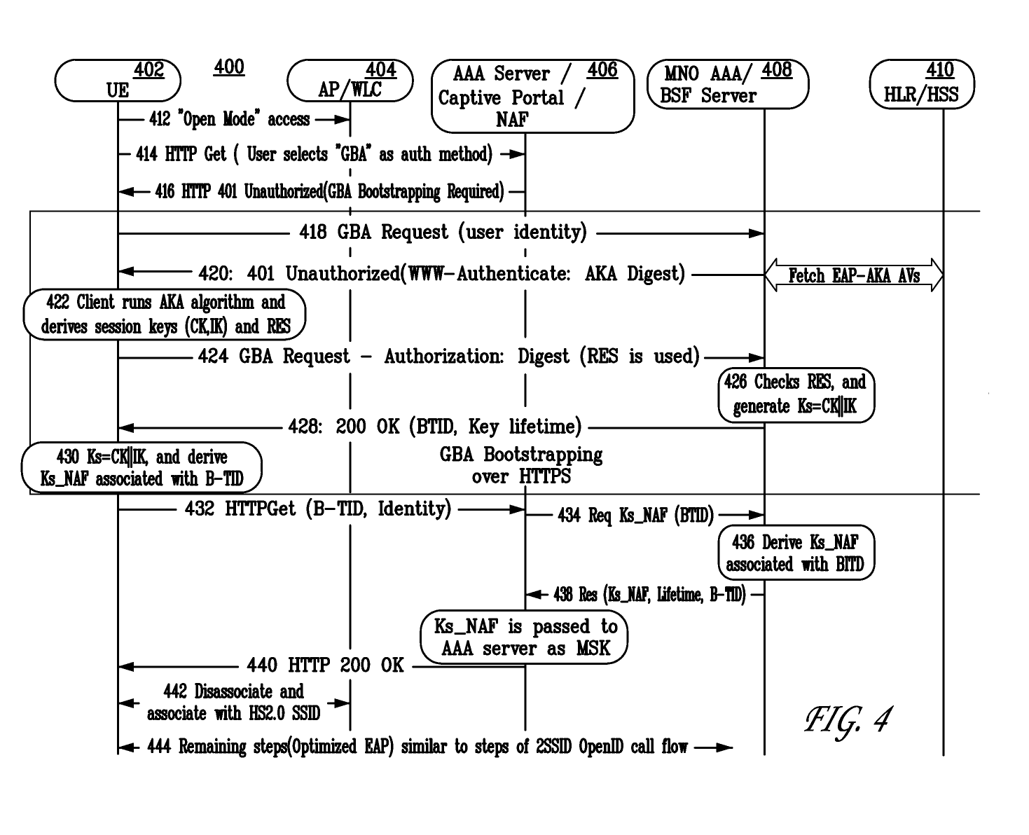

FIG. 4 illustrates an example SSO system 400 that establishes a secure network connection based on GBA protocol. A GBA protocol can be implemented as desired to provide mutual authentication and generate session keys. For example, the illustrated embodiment implements a GBA-AKA protocol, although embodiments are not so limited. The GBA credentials generated via GBA-AKA authentication are used to provide optimized secure HS 2.0 access.

In the illustrated embodiment shown in FIG. 4, at 412, a UE 402 associates with an AP/WLC 404. For example, the UE 402 may be first associated with the AP 404 using a “Public WLAN” SSID and open mode access. If the UE 402 is configured to get an IP address using DHCP, for example, the AP/WLC 404 allocates a private IP address to the UE 402. In an example embodiment, the UE 402 cannot access the Internet using the allocated IP address and the state of the UE 402 in the AP/WLC 440 is “unauthorized”. When the user of the UE 402 opens its web browser application, a Captive portal/NAF 406 may redirect the browser to a portal page that prompts the user for login credentials. The captive portal 406 may be implemented by an AAA Server 406, and the AAA server 406 may implement a NAF, so the AAA server 406 may also be referred to as a NAF 406 or an AAA server/NAF 406, without limitation. At 414, the user/UE 402 selects GBA authentication. At 416, the NAF 406 intercepts the HTTP message and notifies the UE 402, using an HTTP 401 unauthorized message, to authenticate with a BSF 408. The AP/WLC 404 406 opens port 443 for communications between the UE 402 and the BSF 408. During steps 418, 420, 422, 424, 426, and 428, the UE 402 and the BSF 408 complete the GBA protocol. The end result of the GBA protocol is a security association between the UE 402 and BSF 408 which include a GBA keys (Ks), a bootstrapping transaction identifier (B-TID), and a key lifetime.

In accordance with the illustrated embodiment, at 430, the UE 402 uses Ks to derive Ks NAF that is associated with the B-TID. At 432, the UE 402 sends the B-TID with the identity of the UE 402 to the NAF 406. At 434, the NAF 406 contacts the BSF 408 with the B-TID to retrieve the Ks NAF. At 436, the BSF 408, upon verifying the B-TID, derives the Ks NAF that is associated with the B-TID. At 438, the BSF 408 sends the Ks NAF to the NAF/AAA server 406. For example, the NAF 406 may receive the Ks NAF and derive the MSK, and then pass it internally to its AAA server 406 as an MSK. At 440, the AAA server/NAF 406 sends an HTTP 200 OK message to the UE 402. In accordance with the illustrated embodiment, at 442, the UE 402 disassociates from the “open” SSID and associates with a secure SSID, such as a secure HS 2.0 SSID for example. At 444, the UE 402 may perform an optimized EAP. For example, the UE 402 may send its identity (EAP ID) to the AP/WLC 404 using EOL-Start Identity. The realm of the EAP ID may include a hint to use an existing security context between the UE 402 and the network. The AP 404 may send a RADIUS Access-Request message that contains the EAP ID toward the AAA Server 406. The AAA Server 406 may send EAP-Success along with the MSK that is previously received to the AP/WLC 404 using a RADIUS Access-Accept message for example. The AP/WLC 404 may forward the EAP success message to the UE 402. Based on the MSK that is shared between the UE 402 and the AP/WLC 404, the 4-way Handshake protocol is performed and PTK and GTK keys are derived on both sides. The UE 402 status may become “authorized” on the AP 402. The UE 402 obtains IP address configurations using DHCP for example, and the UE 402 may connect to the internet securely via HS 2.0.

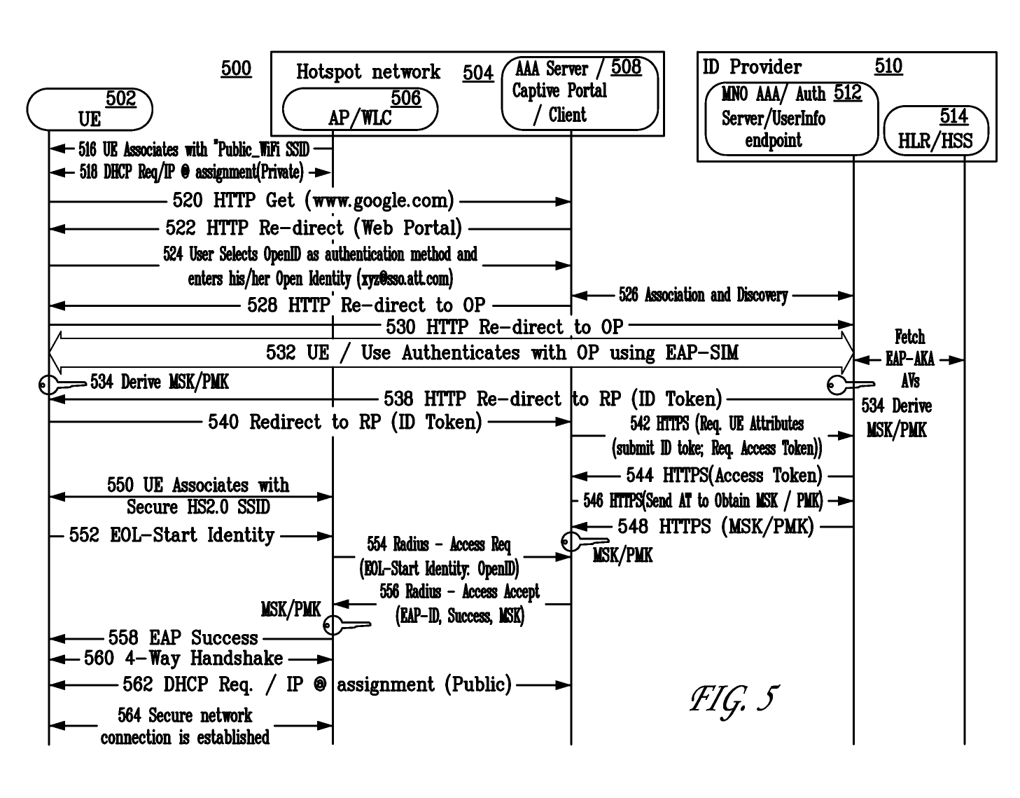

FIG. 5 illustrates an example SSO system 500 that establishes a secure network connection based on OpenID protocols, such as OpenID Connect (OIDC). OIDC provides a mechanism for users to authorize an OP to divulge specified user profile information to a RP/Client. In the illustrated embodiment shown in FIG. 5 in which WLAN access is sought, the MSK/PSK is divulged to the RP/Client 508, which may also be referred to as the AAA proxy 508 or the captive portal 508, without limitation. The MSK/PMK may be derived as part of the authentication of a UE 502. OIDC defines identity (ID) and access tokens, which may be used to obtain user attributes and/or profile information and/or session keys, such as MSK/PMK for example, by the RP/Client 508.

In accordance with the illustrated embodiment, two SSIDs are used in conjunction with the OIDC for the UE 502 to be authenticated for access to a hotspot network 504. The hotspot network 504 includes an AP/WLC 506 and a client/AAA proxy 508. The “Public WiFi” SSID referenced in FIG. 5 is open and non-secure while the HS 2.0 is secure. In accordance with the illustrated embodiment, the authentication is initiated over the open Public WLAN. After the initial authentication, the cryptographic material and identity derived as part of the authentication is used by the UE over the secure HS 2.0 SSID to complete authentication and authorization.

With continuing reference to FIG. 5, at 516, the UE 502 associates with an open SSID of the AP/WLC 506. At 518, the UE 502 obtains a private internet protocol address using DHCP. At 520, the user of the UE 502 attempts to connect to the internet. At 520 and 522, the captive portal 508 intercepts the HTTP Get message and re-directs the HTTP message back to the UE 502 displaying captive portal information. At 524, the UE uses the message received at 522 as cue for requiring authentication. The UE provides its SSO identity, such as an MNO provided SSO identity such as an email address using the operator id in the “realm” portion for example. At 526, the captive portal 508 functions like an OpenID connect client, and thus the captive portal can be referred to as the client 508. The client 508 starts the association/discovery with an authorization server 512 which may function as AAA server in the operator network, and thus maybe referred to as an AAA server 512. The authorization server 512 may further function as a user information endpoint when the OpenID connect protocol is implemented, and thus the authorization server 512 may be referred to as a user information (UserInfo) endpoint 512. At the end of the discovery/association at 526 a secure connection is created between the client 508 and the authorization server 512.

At 528 and 530, the client 508 performs HTTP re-direct to the authorization server 512 via the UE 502. In accordance with the illustrated embodiment, the UE 502 and the authorization server 512 perform EAP-SIM mutual authentication at 532. The resulting key generated at the end of the authentication is a master session key (MSK), which is generated at the UE 502 and at the authorization server 512. The authorization server 512, in accordance with the Open ID Connect protocol, performs HTTP re-direct to the client 508 via the UE 502, at 538 and 540. The re-direct comprises the ID token. At 542, the client 508 uses the ID token to request an access token via the HTTPS connection that was established between the client 508 and the authorization server 512. At 544, the authorization server 512 provides the access token to the client 508, for example, after the ID token is presented to the authorization server 512 and verified by the authorization server 512. At 546, the access token is sent to the UserInfo endpoint 512 to obtain the MSK/PMK, for example. At 548, the UserInfo endpoint 512 verifies the access token and sends the MSK/PMK to the client 508 which stores the key. For example, once the UE 502 is notified of a successful authentication (e.g., upon receipt of the HTTP re-direct message from the authorization server 512), the UE 502 associates with the secure HS 2.0 SSID at 550.

In accordance with the illustrated embodiment shown in FIG. 5, at 552, the UE 502 starts the EAP authentication and sends its SSO identity which it used earlier in the illustrated call flow. At 554, the AP 506, upon receiving the EAP-Start message, forwards it to the AAA proxy/Client 508 using a Radius Access message. At 556, the AAA proxy/Client 508 confirms the successful authentication and the presence of a MSK/PMK, and forwards an EAP-Success message with the MSK/PMK to the AP 506. The AP 506 may store the MSK/PSK. At 558, the AP 506 sends the EAP-Success message to the UE 502. Once the EAP-Success messages is received by the UE 502, it initiates the 4-way handshake at 560 in accordance with the illustrated embodiment. After the 4-way handshake, the UE 502 obtains a public IP address, at 562. At 564, the UE 502 uses the HS 2.0 to access the internet and a secure network is established between the UE 502 and the hotspot network 504.

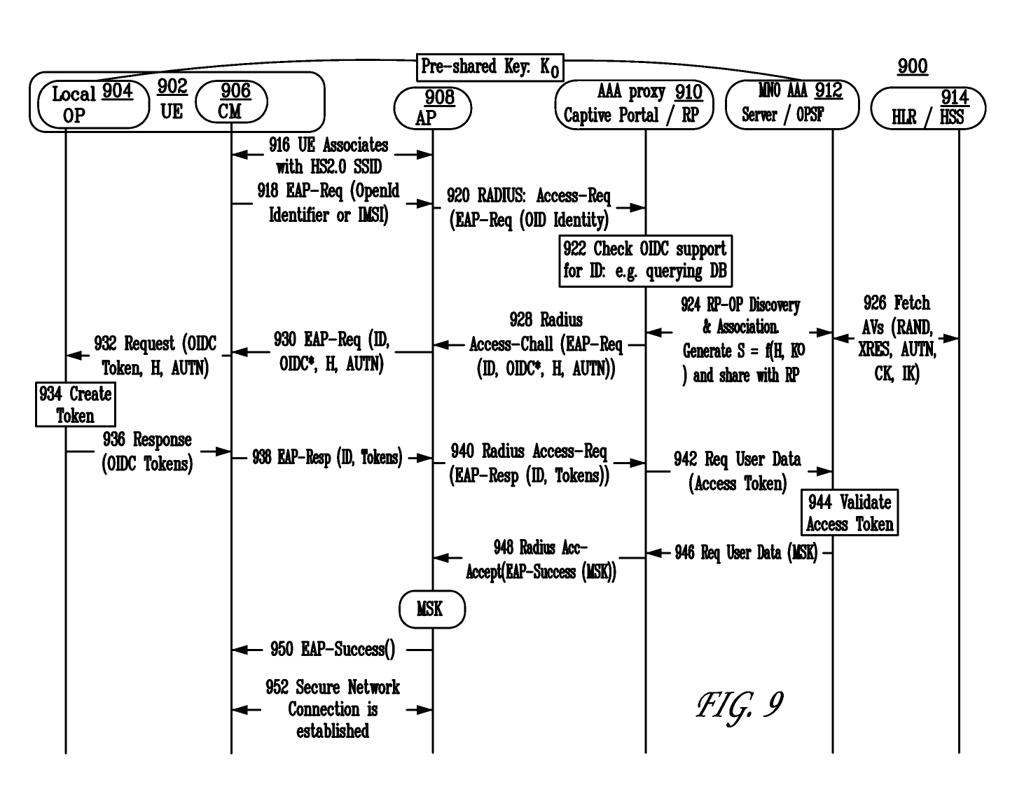

FIG. 9 illustrates an example SSO system 900 that implements local OP functionality to establish a secure network connection based on OpenID connect. The SSO system 900 includes an UE 902 that includes a local OpenID identity provider (OP) and a connection manager (CM) 906. The local OP 904 resides on the UE 902, and the local OP may perform various functions of the OpenID protocols. Thus, the local OP 904 may also be referred to as a local assertion function (LAF) 904. The SSO system 900 further includes an AP 908, an AAA proxy server 910, and an MNO AAA server 912. The AAA proxy 910 may also function as a captive portal or a relying party (RP), and thus the AAA proxy 910 may also be referred to as a captive portal 910 or an RP 910, without limitation. Similarly, the MNO AAA server 912 may function as an OP server, and thus may be referred to as an OpenID server function (OPSF) 912, without limitation. The SSO system 900 further includes a home location register (HLR)/home subscriber system (HSS) 914.

Referring to the illustrated embodiment shown in FIG. 9, at 916, a local component on the UE 902, for example the CM 906, discovers the AP 908 (e.g., HS 2.0 AP) and connects to the AP 908. At 918, the UE 902 returns its international mobile subscriber identity (IMSI) with its realm to the AP 908. The realm may include a hint to use SSO authentication (e.g., IMSI@sso.MNO.org. At 920, in accordance with the illustrated embodiment, the AP 908 forwards the identity of the UE 902, which was received from the UE 902 using an EAP message, to the AAA proxy server 910 using a RADIUS Access Request. At 920, the AAA proxy server 910 detects that the UE 902 is capable of using the OpenID Connect (OIDC) based flow. Such a detection may be based on the indicator that was received by the AAA proxy server 910. Alternatively, the AAA proxy server may detect that the UE is capable of OIDC by looking up the received IMSI of the UE 902 in a database. At 924, the RP 910 performs a discovery of the OPSF 912 and associates with the OPSF 912. As part of the association, a shared secret is created by the OPSF 912 based on a handle that is generated by the OPSF 912. The shared secret may be of the form S=f(K0, H), where K0 is the shared secret between the Local OP 904 and the OPSF 912. At 926, the OPSF/AAA Server 912 may optionally fetch the AUTN that is associated with the UE 902 from the HLR/HSS 914. At 924, the shared secret S, the handle H and optionally the AUTN are sent by the OPSF 912 to the AAA proxy 910. At 928, the AAA proxy server 910 sends an EAP-SIM/AKA challenge to the AP 908 indicating that OpenID Connect may be used in the EAP protocol. The handle H and the AUTN may be sent to the AP 908. Instead of an indication, for example, the AAA proxy server 910 may create an OpenID Connect request object (e.g., JSON) and put an indicator (e.g., URL) to it into the request. At 930, the AP 908 forwards the EAP message that was received from the AAA proxy server 910 (EAP-Request/Challenge) to the CM 906, and thus to the UE 902. After receiving the EAP-Request/Challenge message, the UE 902 checks the authentication parameters and uses the OpenID Connect request object to initiate an OpenID Connect session with the local OP 904, at 932.

In accordance with the illustrated embodiment, at 934, the local OP 904 creates an access token, for example, after a successful local user authentication. The local OP 904 may also optionally create an ID token. The Access token may be created by using the handle H and/or the AUTN. Similarly the ID token may be created using the handle H and/or the AUTN. At 936, the access token is returned to the CM 906. At 938, the CM 906 sends the access token in the EAP message to the AP 908. Further, at 938, the CM 906 may optionally send the ID token in the EAP message to the AP 908. At 940, the AP 908 forwards the EAP-Response/Challenge message to the AAA proxy server 910. At 942, the AAA proxy 910 verifies the access token and uses the token with the user information endpoint from the OP 912 to retrieve data. Further, at 942, the AAA proxy 910 may optionally verify the ID token. In accordance with the illustrated embodiment, the OP 912 validates the access token before it releases the user information. The OP 912 may optionally validate the ID token. According to the example embodiment, the user information includes a master session key (MSK). At 946, the AAA proxy 910 receives the MSK from the AAA server 912. At 948, when the checks are successful, for example, the AAA proxy server 910 sends an Access Accept message to the AP 908. The Access Accept message may include an EAP success message and the keying material, for example the MSK. At 950, the EAP Success message is forwarded to the UE 902 by the AP 908. At 952, a secure connection is established between the UE and the AP 908 which may be a HS 2.0 AP.

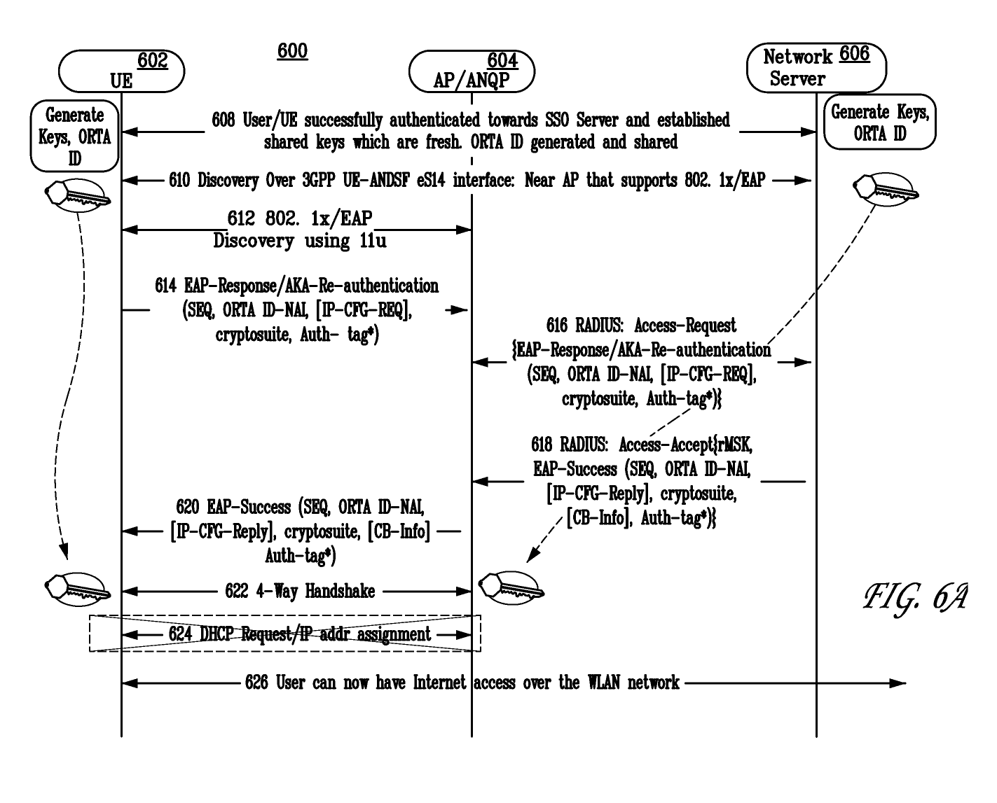

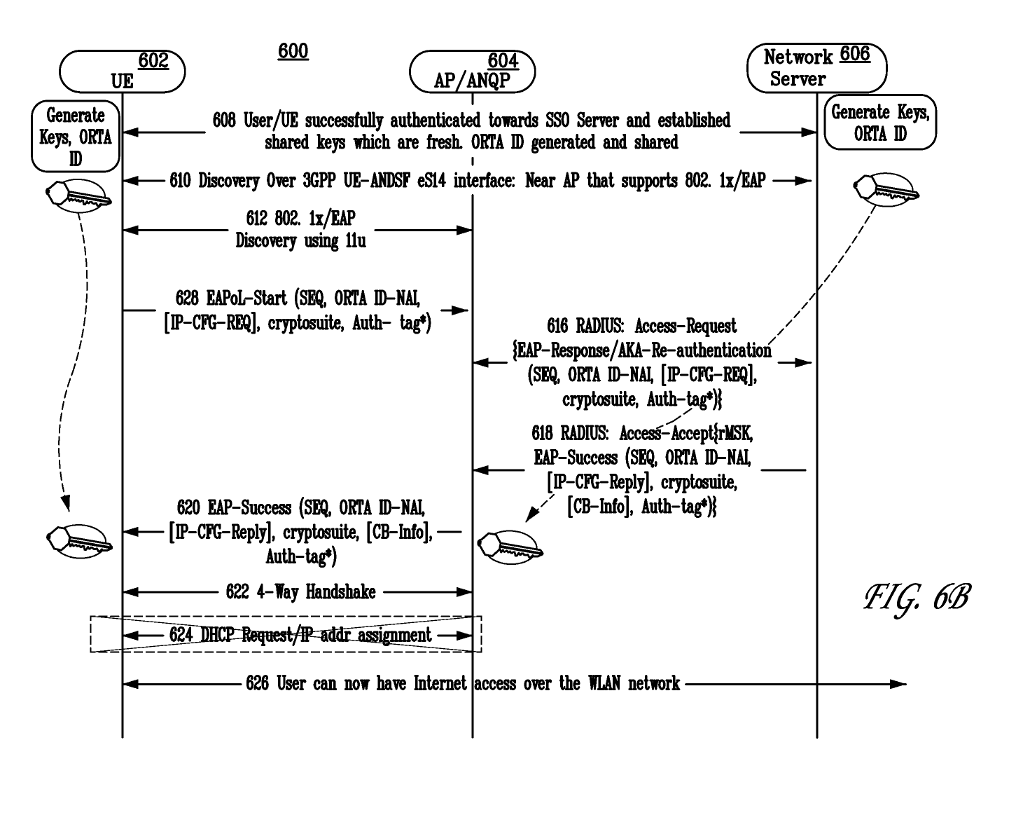

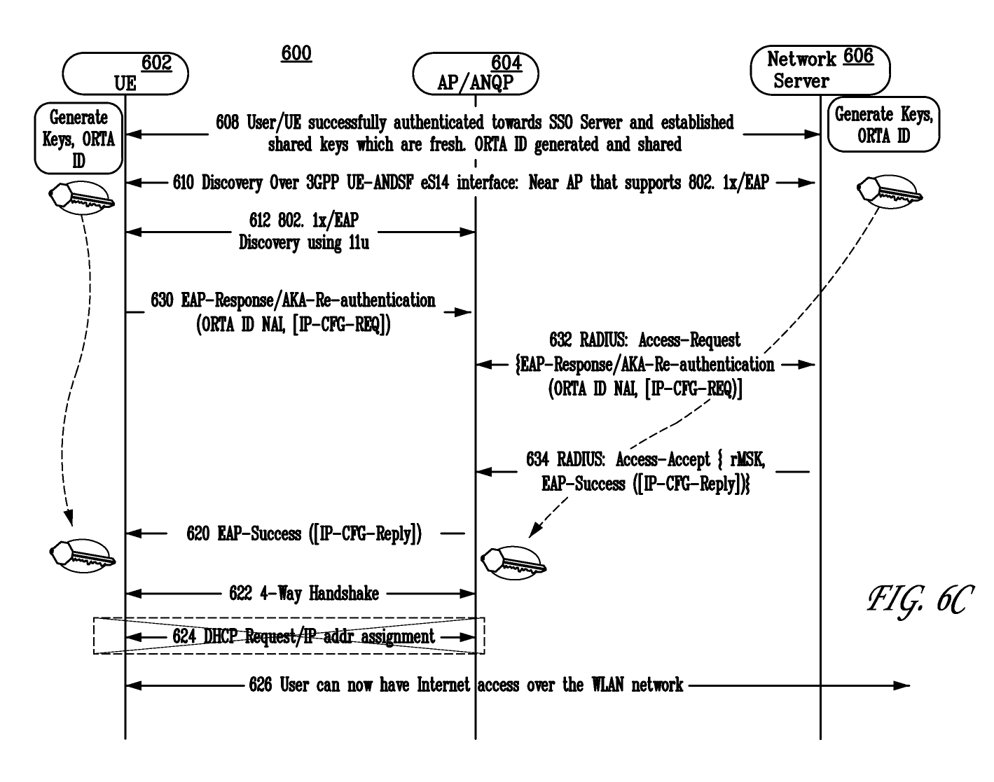

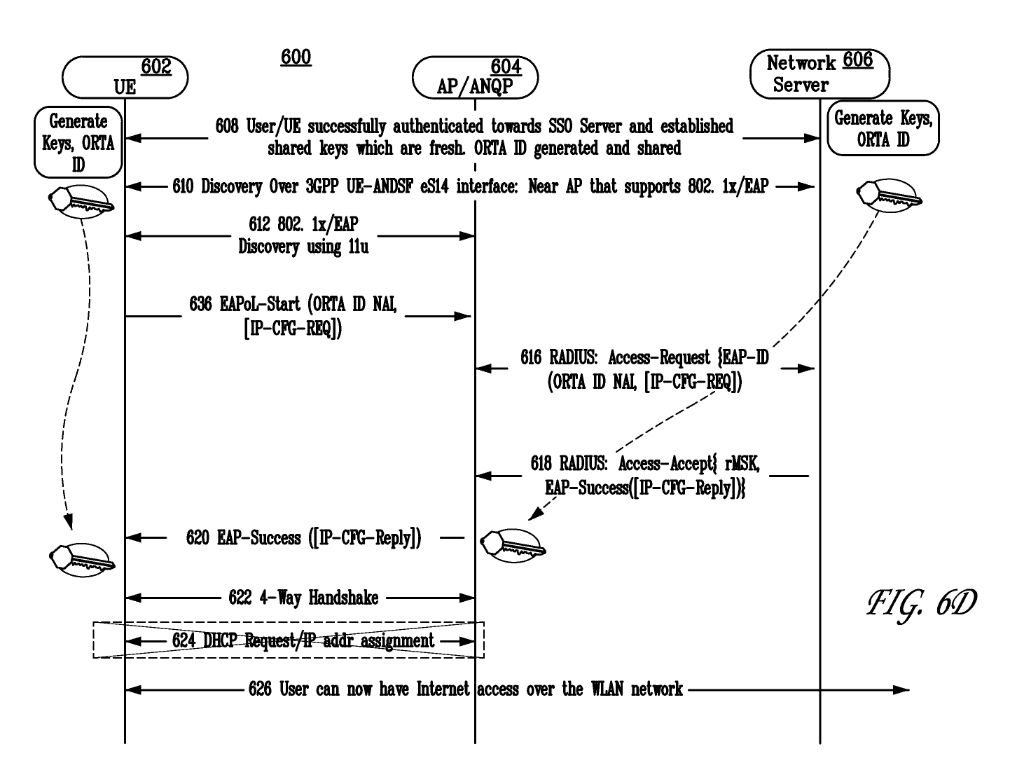

FIG. 6A illustrates an example embodiment of EAP-AKA authentication using an SSO system 600. In the illustrated embodiment, ORT authentication is triggered using an EAP-Response message. The SSO system 600 includes a UE 602, an access point (AP) 604, and a network server 606. The network server 606 may implement an OpenID protocol, and thus may be referred to as an OpenID server 606. The network server 606 may also be referred to, without limitation, as an SSO server 606, a Federated Identity server 606, an access network discovery and selection function (ANDSF) server 606, or an AAA server 606. In accordance with the illustrated embodiment shown in FIG. 6A, at 608, the UE 602 and the network server 606 have pre-established a security association and generated fresh master keys. In an example embodiment in which security association between the UE 602 and the network server 606 has not been established, an active connection, such as an active Cellular connection for example, between the UE 602 and the network server 606 may be used to mutually authenticate and generate master keys on the UE 602 and the network server 606. At 608, an one round trip authentication (ORTA) ORTA identity (ID) is created and sent securely from the network server 606 to the UE 602. Such an ORTA ID may be used to trigger ORT EAP authentication and may be used by the network server 606 to find the existing security association context with the UE 602.

At 610, network discovery information may be exchanged between the UE 602 and the network. For example, the UE 602 may request wireless local area network (WLAN) information from the ANDSF server 606 (e.g., pull scenario) or the ANDSF server 606 may push WLAN information to the UE 602. The WLAN information may be pushed over a secure connection, such as a secure Cellular connection for example. The network information that the UE 602 receives may comprise data such as available APs, SSIDs, authentication protocols which are supported (e.g., EAP-AKA and EAP-ORT are supported), cryptosuites, IP address configurations, or other access network parameters. In an alternative example embodiment, with reference to 612, network discovery information is obtained using lower layers such as by using 802.11u (e.g., using GAS and access network query protocol (ANQP)). In accordance with the illustrated embodiment, the network discovery information includes an indication that the AP 604 network supports EAP-ORTA.

At 614, in accordance with the illustrated embodiment, the UE 602, in response to the network discovery information, informs the UE 602 that the AP 604 supports EAP-AKA and EAP-ORT, sends an EAP-Response/AKA-Reauthenticate message to the AP 604. The message includes the ORTA identity that may be securely stored in the UE. The message may further include a sequence number (SEQ) for replay protection and a crypto suite that may be used. The initiate message may be protected using the integrity key. In an example embodiment, the UE 602 requests the IP address configuration by including a request (e.g., IP_CFG_REQ) in the EAP message at 614. In another example embodiment, the UE 602 may request IP address configurations by encapsulating DHCP requests inside EAP messages. In yet another example embodiment, the UE 602 may request and may obtain IP address configurations using EAP-Notify messages. At 616, the AP 604 forwards the EAP message (e.g., using AAA Request) to the network server 606. At 618, the network server 606 uses the ORTA identity to look up the pre-established security context with the UE 602. The network server 606 may verify the sequence number and may verify that the crypto suite used by the UE 602 is acceptable. The network server 606 may verify the integrity of the message using the integrity key. For example, such a verification provides proof of the key possession by the peer 602. If the verifications are successful, the network server 606 generates and sends a session key to the AP 604. The session key may be sent with an EAP-Success message.

Still referring to FIG. 6A, in an example embodiment in which the UE 602 sends an IP configuration request (e.g., IP_CFG_FEQ) in the EAP-Response message, the network server 606 may send the IP configurations to the UE 602. For example, required IP configurations may be sent in a IP CFG Reply field of the EAP-Success message. The network server 606 may use various configuration protocols (e.g., DHCP, configured local address pool, or the like) to send address configuration information to the UE 602. The network server 606 may send channel binding information (CB-Info) in the EAP-Success message, for example, for the UE 602 to verify that the EAP message was received via a valid AP. A valid AP may refer to an AP that has not been compromised. In accordance with the illustrated embodiment shown in FIG. 6A, at 620, the AP 604 forwards the EAP-Finish message to the UE 602. At 622, a 4-Way Handshake protocol is performed. IP address configuration may be performed at 624. In an example embodiment, IP address configuration is skipped at 624 because various IP concurrency options may be used. At 626, the UE 602, and thus a user of the UE 602, has secure access to the internet via the AP 604 and the WLAN.

FIG. 6B illustrates an example embodiment in which EAP-AKA ORTA may be triggered using a EAPoL-Start message, at 628. The description of the call flow steps and entities that are illustrated in FIG. 6B are that are common to FIG. 6A are described with respect to FIG. 6A. In the illustrated embodiment shown in FIG. 6B, the UE 602 triggers ORT authentication using a EAPoL-Start message instead of a EAP-Response message shown in FIG. 6A.

FIG. 6C illustrates another example embodiment in which EAP-AKA ORTA may be triggered using an EAP-Response message. In accordance with the illustrated embodiment, the EAP message in steps 630, 632, and 634 is not integrity protected. For example, EAP message protection may be relaxed since EAP authentication is followed by a 4-way handshake protocol. The 4-way handshake protocol may be used to protect against security breaches that may have occurred prior to the handshake protocol.

Referring to FIG. 6C, the description of the call flow steps and entities that are illustrated in FIG. 6C and are that are common to FIG. 6A are described with respect to FIG. 6A. At 630, the UE 602, based on the network discovery information, knows that the AP 604 supports EAP-AKA and EAP-ORT, and sends an EAP-Response/AKA-Reauthenticate message to the AP 604. The EAP message includes the ORTA identity and may include an IP configuration request (IP_CFG_REQ). In accordance with the illustrated embodiment, the EAP message relies on the 4-way handshake protocol (see 622) for providing security protection. At 632, the AP 604 forwards the EAP message using AAA Request) to the network server 606. At 634, the network server 606 uses the ORTA identity to look up the pre-established security context with the UE 602. The network server 606 generates and sends a session key to the AP 604. The session key may be sent with an EAP-Success message. Still referring to FIG. 6C, at 634, in an example embodiment in which the UE 602 sends an IP configuration request (e.g., IP_CFG_FEQ) in the EAP-Response message, the network server 606 may send the IP configurations to the UE 602. For example, required IP configurations may be sent in a IP CFG Reply field of the EAP-Success message. The network server 606 may use various configuration protocols (e.g., DHCP, configured local address pool, or the like) to send address configuration information to the UE 602.

FIG. 6D illustrates another example embodiment in which EAP-AKA ORTA may be triggered using a EAPoL-Start message, at 636. The description of the call flow steps and entities that are illustrated in FIG. 6D and are that are common to FIG. 6A are described with respect to FIG. 6A. In accordance with the illustrated embodiment shown in FIG. 6D, the UE 602 triggers ORT authentication using a EAPoL-Start message, at 636, instead of an EAP-Response message as shown in FIG. 6C for example.

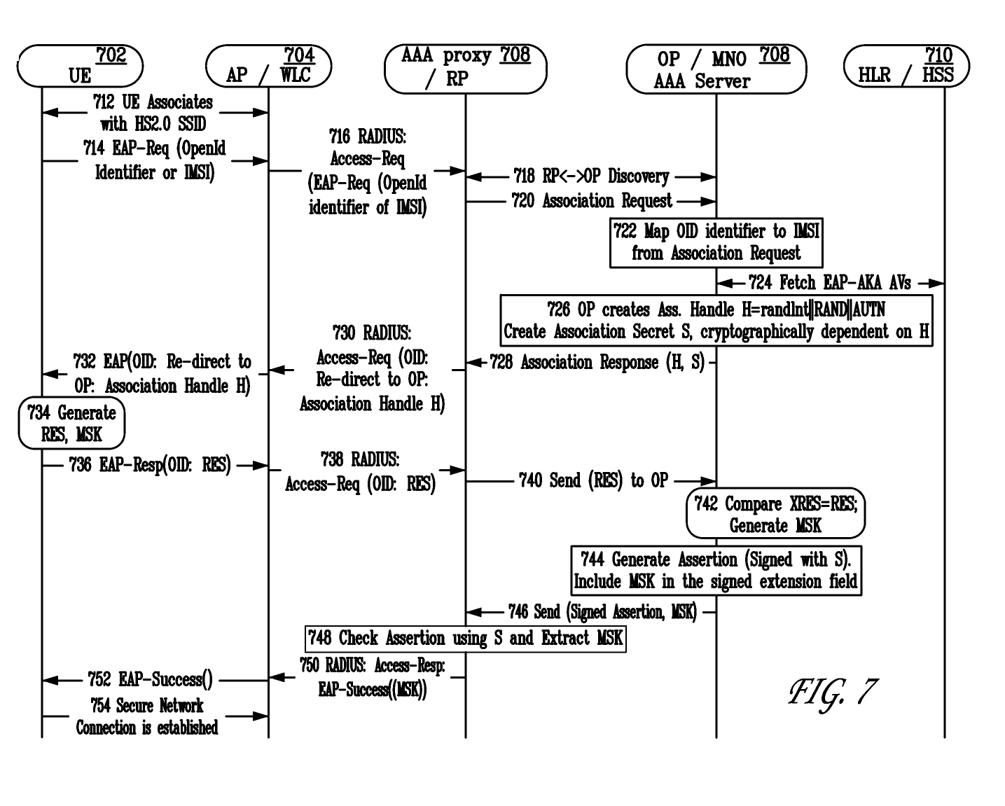

FIG. 7 illustrates an EAP protocol used to encapsulate OpenID messages to enable traversal of OpenID messages within a hotspot network, according to an example embodiment. Transporting OpenID messages within EAP may replace having a captive portal functionality within the hotspot network. Referring to FIG. 7, at 712, a UE 702 associates with a HS 2.0 SSID of a AP/WLC 704. At 714, the UE 702 sends an EAP-Request message that comprises the UE OpenID identifier or IMSI to the AP/WLC 704. At 716, the AP 704 encapsulates EAP-Request message within a Radius Message and forwards it to a AAA Proxy/RP Server 706. The RP 706 performs a discovery process based on the OpenID identifier or IMSI to discover the routing address of a OP Server 708, which may part of an MNO AAA server, and thus the OP 708 may also be referred to as an AAA server 708, without limitation. At 720, after the OP server 708 is discovered, an association request is forwarded to the OP server 708. At 722, the OpenID identifier may be mapped to the IMSI or the IMSI may be extracted from the association request.

With continuing reference to the illustrated embodiment shown in FIG. 7, at 724, based on the IMSI, the AAA Server 708 fetches the authentication vectors (AVs) (e.g., RAND, XRES, AUTN, CK and IK) from a HLR/HSS 710. At 726, upon receiving the AVs, the OP 708 creates an association handle (H). The association handle H=randInt∥RAND∥AUTN in accordance with the illustrated embodiment. The OP 708 creates an association secret (S) using the handle H. At 728, the OP Server 708 sends the handle H and the association Secret S, using an Association Response message via a backend channel to the RP 706. At 730, the AAA proxy 708 encapsulates an OpenID Re-direct message with the Handle H within an Radius/EAP Message and forwards it to the AP/WLC 704. At 732, the AP 704 extracts the EAP message from within the Radius message and forwards the EAP message comprising the OpenID (OID) Re-direct message to the UE 702. At 734, the UE 702 generates the RES based on the AKA algorithm and using the RAND from the association handle H. The UE 702 may generate the MSK and store it for future use. At 736, the UE 702 sends an EAP-Resp message comprising the OpendlD message with the RES. At 738, the AP 704 encapsulates the received EAP message within a Radius Access-Req message and forwards it to the AAA proxy 706. At 740, the AAA proxy 706 processes the Radius/EAP message, extracts the RES, and forwards the RES via the backend channel to the OP 708. The OP 708 receives the RES and compares the received RES to the expected RES, at 742. At 744, the OP server 708 creates a signed assertion that may be signed with the secret S. The MSK that was derived by the AAA server 708 may be included as part of the body of information that is signed by the OP. At 746, the OP 708 sends the signed assertion with the MSK to the RP 706 via the backend channel. The RP 706 checks the assertion and verifies it using the association secret S, and the RP 706 extracts the MSK. At 750, the MSK is encapsulated within an EAP-Success message and wrapped around a Radius Access-Resp packet and sent to the AP 704. At 752, the AP 704 extracts the MSK and stores it, and forwards the EAP-Success message to the UE 702. At 702, using the MSK, the UE 702 and the AP 704 establish a secure network connection. Thus, the UE 702 may have a secure channel to a hotspot network, or another WLAN network for example.

In accordance with the illustrated embodiment, the MSK may be protected by the security of the pre-established HTTPS connection between the RP 706 and the OP 708. In an alternative example embodiment, the OP is separated from the MNO AAA server. For example, the MNO may not want to implement OP functionality, or a third party may offer the OP service to both hotspot networks and MNOs to aggregate them in a federated business model.

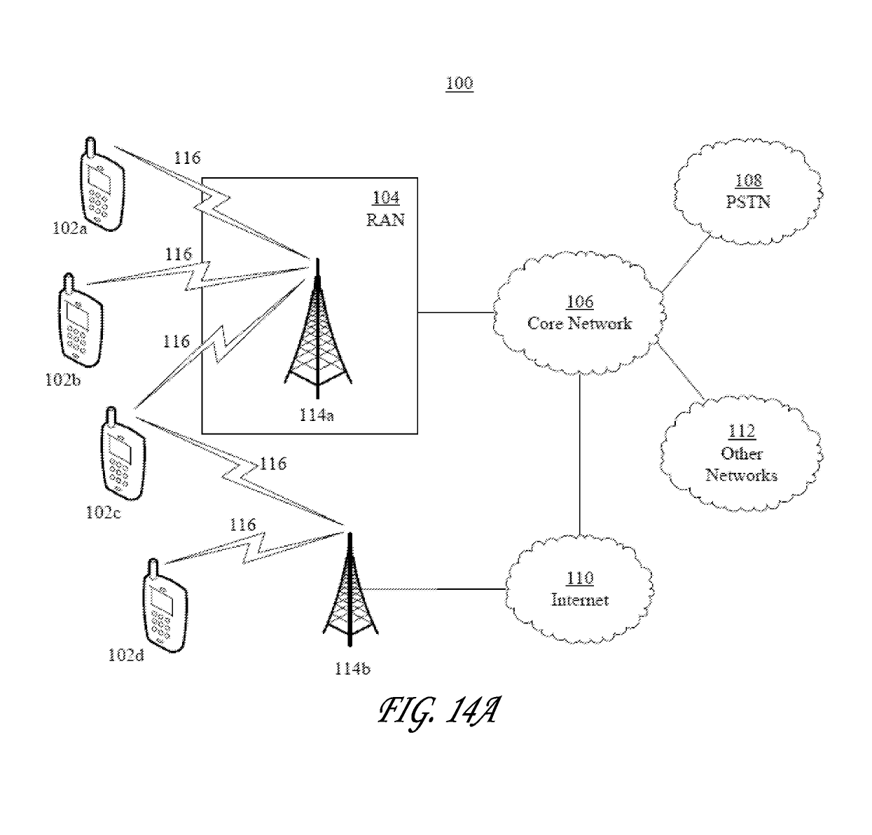

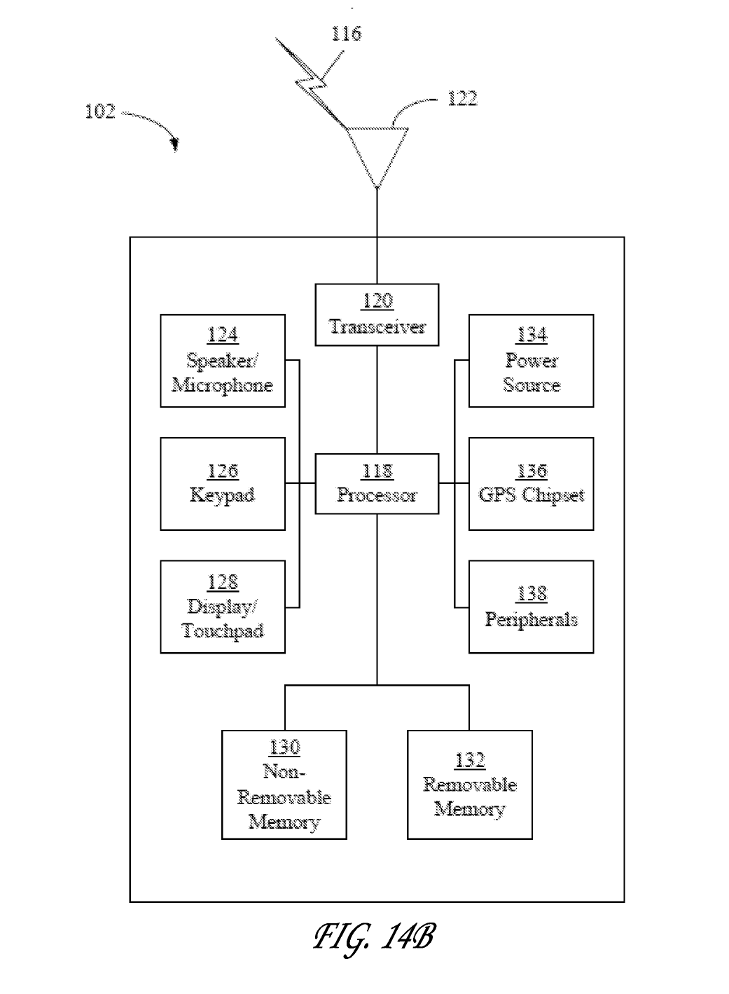

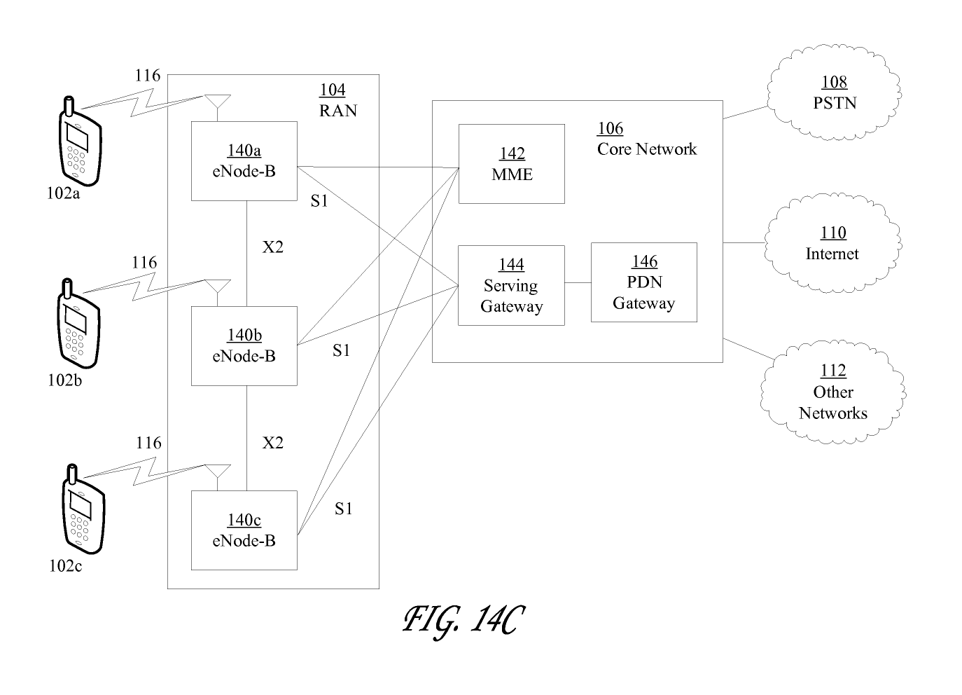

FIG. 14A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 14A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 14A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 14A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 14A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different

RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 14A may be configured to communicate with the base station 114a, which may employ a cellular-based radio technology, and with the base station 114b, which may employ an IEEE 802 radio technology.

FIG. 14B is a system diagram of an example WTRU 102. As shown in FIG. 14B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 14B depicts the processor 118 and the transceiver 120 as separate components, it will be appreciated that the processor 118 and the transceiver 120 may be integrated together in an electronic package or chip. The processor 118 may perform application-layer programs (e.g., browsers) and/or radio access-layer (RAN) programs and/or communications. The processor 118 may perform security operations such as authentication, security key agreement, and/or cryptographic operations, such as at the access-layer and/or application layer for example.

In an example embodiment, the WTRU 102 comprises a processor 118 and memory coupled to the processor. The memory comprises executable instructions that when executed by the processor cause the processor to effectuate operations associated with one round trip authentication.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 14B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 14C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 14C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 14C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out and/or support other functionality, such as outer loop power control, load control, admission control, packet scheduling, handover control, macrodiversity, security functions, data encryption, and the like.

The core network 106 shown in FIG. 14C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. For example, while embodiments may be described herein using OpenID and/or SSO authentication entities and functions, similar embodiments may be implemented using other authentication entities and functions. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed at a user equipment (UE), the method comprising:
establishing a security association with a single sign-on (SSO) server on a first network;
discovering a network identity of an access point on a second network;
deriving, with the SSO server, dynamically generated credentials for use in accessing the access point on the second network; and
performing an optimized authentication using the dynamically generated credentials to gain secure access to the access point via the second network.

2. The method as recited in claim 1, wherein the first network is a cellular network and the second network is a hotspot network or a WLAN network.

3. The method as recited in claim 1, wherein the network identity is discovered via the first network.

4. The method as recited in claim 1, wherein the credentials are derived with the SSO server via the first network or via a direct connection with the SSO server.

5. The method as recited in claim 1, wherein the optimized authentication is performed in accordance with an optimized extensible authentication protocol (EAP) framework.

6. The method as recited in claim 1, wherein the dynamically generated credentials comprise a master session key (MSK).

7. The method as recited in claim 1, wherein the SSO server is an OpenID identity provider and the access point is a relying party, and wherein the OpenID identity provider and the relying party transfer one or more access tokens between each other.

8. The method as recited in claim 1, wherein the optimized authentication is performed when the UE is within a communication range of the access point.

9. The method as recited in claim 1, wherein the first network is controlled by a mobile network operator (MNO), and the SSO server is controlled by the MNO.

10. The method as recited in claim 1, the method further comprising:
authenticating with a bootstrapping server function (BSF) in accordance with a generic bootstrapping architecture (GBA) protocol; and
based on the authentication with the BSF, disassociating with an open mode service set identifier (SSID) of the access point and associating with a secure SSID of the access point.

11. The method as recited in claim 1, the method further comprising:
authenticating with an OpenID identity provider (OP) in accordance with an OpenID protocol; and
based on the authentication with the OP, disassociating with an open mode service set identifier (SSID) of the access point and associating with a secure SSID of the access point.

12. A wireless/transmit receive unit (WTRU), the WTRU comprising:
a memory comprising executable instructions; and
a processor in communications with the memory, the instructions, when executed by the processor, cause the processor to effectuate operations comprising:
establishing a security association with a single sign-on (SSO) server on a first network;
discovering a network identity of an access point on a second network;
deriving, with the SSO server, dynamically generated credentials for use in accessing the access point on the second network; and
performing an optimized authentication using the dynamically generated credentials to gain secure access to the access point via the second network.

13. The WTRU as recited in claim 12, wherein the first network is a cellular network and the second network is a hotspot network or a WLAN network.

14. The WTRU as recited in claim 12, wherein the network identity is discovered via the first network.

15. The WTRU as recited in claim 12, wherein the credentials are derived with the SSO server via the first network or via a direct connection with the SSO server.

16. The WTRU as recited in claim 12, wherein the optimized authentication is performed in accordance with an optimized extensible authentication protocol (EAP) framework.

17. The WTRU as recited in claim 12, wherein the dynamically generated credentials comprise a master session key (MSK).

18. The WTRU as recited in claim 12, wherein the SSO server is an OpenID identity provider and the access point is a relying party, and wherein the OpenID identity provider and the relying party transfer one or more access tokens between each other.

19. The WTRU as recited in claim 12, wherein the optimized authentication is performed when the UE is within a communication range of the access point.

20. The WTRU as recited in claim 12, wherein the first network is controlled by a mobile network operator (MNO), and the SSO server is controlled by the MNO.

21. The WTRU as recited in claim 12, wherein the processor is further configured to execute the instructions to perform operations comprising:
authenticating with a bootstrapping server function (BSF) in accordance with a generic bootstrapping architecture (GBA) protocol; and
based on the authentication with the BSF, disassociating with an open mode service set identifier (SSID) of the access point and associating with a secure SSID of the access point.

22. The WTRU as recited in claim 12, wherein the processor is further configured to execute the instructions to perform operations comprising:
authenticating with an OpenID identity provider (OP) in accordance with an OpenID protocol; and
based on the authentication with the OP, disassociating with an open mode service set identifier (SSID) of the access point and associating with a secure SSID of the access point.

23. One or more computer-readable storage media having collectively stored thereon instructions that, upon execution by one or more processors of a computer system, cause the computer system to at least:
establishing a security association with a single sign-on (SSO) server on a first network;
discovering a network identity of an access point on a second network;
deriving, with the SSO server, dynamically generated credentials for use in accessing the access point on the second network; and
performing an optimized authentication using the dynamically generated credentials to gain secure access to the access point via the second network
